(19) United States
(12) Patent Application Publication
(10) Pub. No.: US 2017/0286118 A1
(43) Pub. Date: Oct. 5, 2017

(54) PROCESSORS, METHODS, SYSTEMS, AND INSTRUCTIONS TO FETCH DATA TO INDICATED CACHE LEVEL WITH GUARANTEED COMPLETION

(71) Applicant: Intel Corporation, Santa Clara, CA (US)

(72) Inventors: James A. Coleman, Mesa, AZ (US); Philip C. Arellano, Tempe, AZ (US); Garrett Drown, Chandler, AZ (US)

(21) Appl. No.: 15/088,327

(22) Filed: Apr. 1, 2016

(51) Int. Cl. G06F 9/38; G06F 9/30; G06F 12/08

(52) U.S. Cl. CPC G06F 9/3802; G06F 12/0862; G06F 12/0875; G06F 9/3016; G06F 2212/452

(57) ABSTRACT

A processor of an aspect includes a plurality of caches at a plurality of different cache levels. The processor also includes a decode unit to decode a fetch instruction. The fetch instruction is to indicate address information for a memory location, and the fetch instruction is to indicate a cache level of the plurality of different cache levels. The processor also includes a cache controller coupled with the decode unit, and coupled with a cache at the indicated cache level. The cache controller, in response to the fetch instruction, is to store data associated with the memory location in the cache, wherein the fetch instruction is architecturally guaranteed to be completed. Other processors, methods, systems, and machine-readable storage mediums storing instructions are disclosed.

### BACKGROUND

### Technical Field

Embodiments described herein generally relate to processors. In particular, embodiments described herein generally relate to loading data from memory into processor.

### Background Information

In order to improve performance processors typically have at least one cache. The cache may represent a relatively small, fast access, local storage, which is relatively close to the processor. During operation, a subset of the data in the system memory may be stored in the cache. When the processor wants to read data from the system memory, or write data to the system memory, the processor may first check to see if a copy of the data is stored in the cache. If the data is stored in the cache, then the processor may access the data from the cache instead of needing to access the data from the system memory. Generally, the data can be accessed from the cache much more quickly than from the system memory. By way of example, accesses to the data from the cache may generally take no more than a few processor clock cycles, whereas accesses to the data in the system memory generally take at least an order of magnitude longer, if not more.

### BRIEF DESCRIPTION OF THE DRAWINGS

The invention may best be understood by referring to the following description and accompanying drawings that are used to illustrate embodiments. In the drawings:

FIG. 1 is a block diagram of a system including an embodiment of a processor and a system memory.

FIG. 2 is a block diagram of an embodiment of a processor that is operative to perform an embodiment of a fetch instruction.

FIG. 3 is a block flow diagram of an embodiment of a method of performing an embodiment of a fetch instruction.

FIG. 4 is a block diagram of a first example embodiment of a fetch instruction.

FIG. 5 is a table illustrating a suitable example of a mapping of different 3-bit cache level indication field values to different indicated cache levels.

FIG. 6 is a block diagram of a second example embodiment of a fetch instruction.

FIG. 7 is a block diagram of an example embodiment of a processor that is operative to perform an embodiment of a fetch instruction.

FIG. 8A is a block diagram illustrating an embodiment of an in-order pipeline and an embodiment of a register renaming out-of-order issue/execution pipeline.

FIG. 8B is a block diagram of an embodiment of processor core including a front end unit coupled to an execution engine unit and both coupled to a memory unit.

FIG. 9A is a block diagram of an embodiment of a single processor core, along with its connection to the on-die interconnect network, and with its local subset of the Level 2 (L2) cache.

FIG. 9B is a block diagram of an embodiment of an expanded view of part of the processor core of FIG. 9A.

FIG. 10 is a block diagram of an embodiment of a processor that may have more than one core, may have an integrated memory controller, and may have integrated graphics.

FIG. 11 is a block diagram of a first embodiment of a computer architecture.

FIG. 12 is a block diagram of a second embodiment of a computer architecture.

FIG. 13 is a block diagram of a third embodiment of a computer architecture.

FIG. 14 is a block diagram of a fourth embodiment of a computer architecture.

FIG. 15 is a block diagram of use of a software instruction converter to convert binary instructions in a source instruction set to binary instructions in a target instruction set, according to embodiments of the invention.

### DETAILED DESCRIPTION OF EMBODIMENTS

Disclosed herein are fetch instructions, processors to execute the fetch instructions, methods performed by the processors when processing or executing the fetch instructions, and systems incorporating one or more processors to process or execute the fetch instructions. In some embodiments, the processors may have a decode unit or other logic to receive and/or decode the fetch instruction, and a cache controller, other execution unit, or other logic to perform the fetch instruction. In the following description, numerous specific details are set forth (e.g., specific instruction operations, data formats, processor configurations, microarchitectural details, sequences of operations, etc.). However, embodiments may be practiced without these specific details. In other instances, well-known circuits, structures and techniques have not been shown in detail to avoid obscuring the understanding of the description.

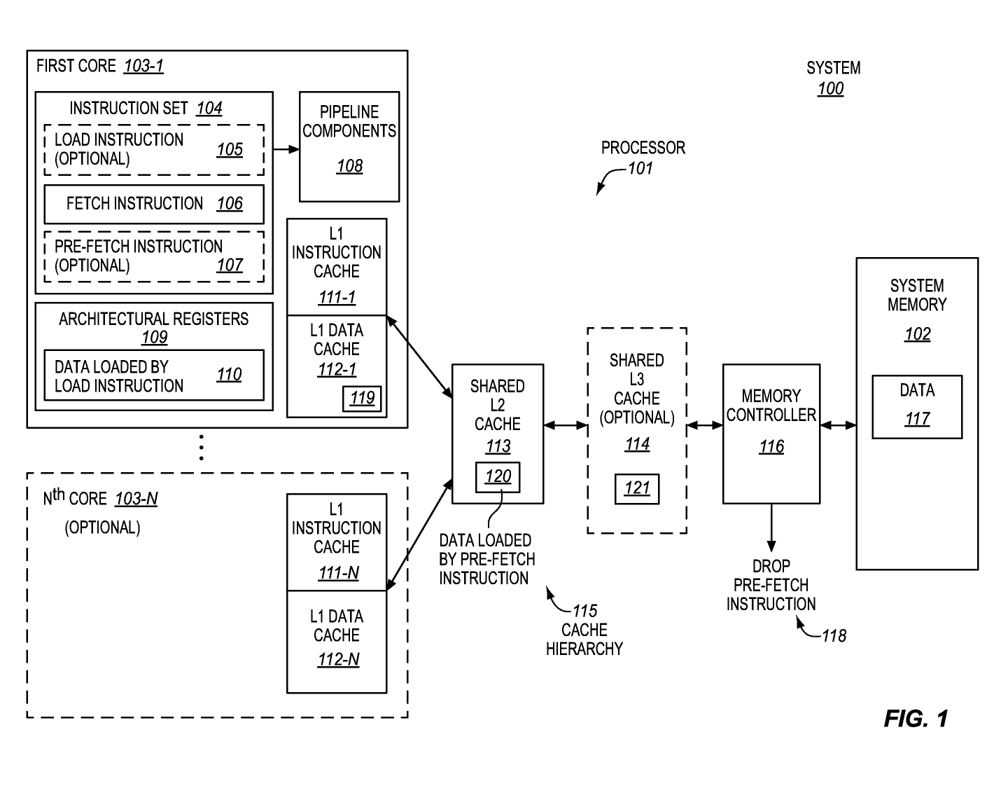

FIG. 1 is a block diagram of a system 100 including a processor 101 and a system memory 102. In various embodiments, the system may represent a desktop computer, a laptop computer, a notebook computer, a tablet computer, a netbook, a smartphone, a cellular phone, a server, a network device (e.g., a router, switch, etc.), a media player, a smart television, a nettop, a set-top box, a video game controller, industrial control device, machine or device having an embedded controller, or other type of electronic device. The processor and the memory may be coupled, or otherwise in communication with one another, by a conventional coupling mechanism (e.g., through one or more buses, hubs, memory controllers, chipset components, or the like).

The processor may optionally be a multiple core processor that may include a first core 103-1 through an Nth core 103-N, where the number of cores may be any reasonable number desired for the particular implementation (e.g., often ranging from one to on the order of tens of cores). The first core has an instruction set 104. The instruction set may include the macroinstructions, machine-level instructions, assembly level instructions, or other instructions or control signals that the processor is able to decode and perform. The first core also has a set of pipeline components 108. By way of example, the pipeline components may include an optional prefetch unit, a fetch unit, a decode unit, a set of execution units, a retirement or other commit unit, optionally out-of-order pipeline components, or the like. The instructions of the instruction set may be provided to the pipeline components to be decoded, executed, or otherwise performed.

The first core also includes architectural registers 109 (e.g., one or more architectural register files). The architectural registers may represent the registers that are visible to software and/or a programmer and/or the registers that are specified or indicated by instructions of the instruction set to identify operands. The architectural registers generally represent on-die processor storage locations that are used to store operands for instructions. The architectural registers may or may not be renamed, aliased, etc. For simplicity, the architectural registers may also be referred to herein simply as registers. The other cores (e.g., the Nth core) may optionally be either the same as, or different than, the first core.

During operation, the processor 101 may load or retrieve data 117 from the system memory 102, process the data, and then store processed or updated data back to the system memory. One challenge is that accesses to the data stored in the system memory generally tend to have relatively high latencies. In order to improve performance, the processor may commonly have at least one cache (e.g., cache 111-1) or a cache hierarchy 115 including multiple caches (e.g., caches 111-1, 111-N, 112-1, 112-N, 113, 114) at different cache levels. Each of the caches may represent a relatively small, fast access, local storage, which is relatively closer to the cores 103 and/or pipeline components 108 (e.g., execution units) than the system memory 102. During operation the caches may be used to cache or store a subset of the data from the system memory that has been loaded into the processor from the system memory. Subsequently, when the processor wants to read data from the system memory, or write data to the system memory, the processor may first check to see if a copy of the data is stored in the caches. If the data is stored in the caches, then the processor may access the data from the caches instead of needing to access the data from the system memory. Generally, the data can be accessed from the cache much more quickly than from the system memory. By way of example, accesses to the data from the cache may generally take no more than a few processor clock cycles, whereas accesses to the data in the system memory generally take at least an order of magnitude longer, if not more. As a result, including one or more caches in the processor may help to reduce the average amount of time needed to retrieve data into the processor which in turn may help to improve processor performance and/or throughput.

Referring again to FIG. 1, the illustrated processor has the cache hierarchy 115 that includes at least two caches (e.g., at least two of caches 111-1, 111-N, 112-1, 112-N, 113, 114) at two or more different cache levels. The cache levels differ in their relative closeness to the cores 103 and/or pipeline components 108 (e.g., execution units) thereof. In the specific example of the cache hierarchy illustrated, the first core 103-1 has a dedicated first level or level 1 (L1) instruction cache 111-1 to cache or store instructions, and a dedicated L1 data cache 112-1 to cache or store data. Similarly, the Nth core 103-1 has a dedicated first level or level 1 (L1) instruction cache 111-N to cache or store instructions, and a dedicated L1 data cache 112-N to cache or store data. Each of the dedicated L1 caches may be dedicated for use by (e.g., to cache data for) the corresponding core in which it is included. The L1 caches are at the cache level closest to the cores and/or their execution units. The specific illustrated cache hierarchy also includes a shared unified second level or level 2 (L2) cache 113. The term unified is used to indicate that the L2 cache may store both instructions and data. The L2 cache is at the next closest cache level to the cores and/or their execution units. The shared L2 cache may be shared by (e.g., cache data for) at least some or all of the cores, as opposed to being dedicated to any particular single core. As shown, the illustrated cache hierarchy may also optionally/potentially include an optional shared unified third level or level 3 (L3) cache 114, although this is not required. The L3 cache may be at a still farther cache level from the cores and/or their execution units, but still closer thereto than the system memory. In another embodiment, instead of the shared L2 cache 113, each of the cores may instead include a dedicated unified L2 cache, and the cache hierarchy may optionally/potentially include a shared L3 cache, and optionally/potentially a shared fourth level or level 4 (L4) cache, although this is not required. Other cache hierarchies are also suitable and may broadly include at least two caches at two or more different cache levels.

Accesses to data from the caches closer to the cores generally tend to be faster than accesses to data from the caches farther from the cores. For example, accesses to data in the L1 caches generally tends to be faster than accesses to data in the L2 caches, accesses to data in the L2 cache generally tends to be faster than accesses to data in the L3 cache, and so on. Accordingly, in some embodiments, it may be beneficial to be able to specify or otherwise identify which cache level is to be used to store a given data and/or instruction. For example, such a decision may be based at least in part on how frequently the data/instruction will be accessed, how important it is to access the data/instruction quickly, how certain it is that the data/instruction will be needed, or the like. In addition, commonly the caches closer to the cores (e.g., the L1 caches) generally tend to be smaller than the caches farther from the cores (e.g., the L2 cache and the L3 cache). Accordingly, the amount of storage space in the smaller caches may be more limited further enhancing the benefit of being able to specify or otherwise indicate which cache level is to be used to cache a given data/instruction based at least in part on the characteristics, intended uses, expectations, and the like for that given data/instruction.

During operation, data in the caches will generally be changed over time by evicting data that has aged and/or is otherwise not likely to be needed in the near future to make room for data that is likely to be needed in the near future. Various replacement algorithms and policies are known in the arts for this purpose. Such replacement algorithms and policies often base evictions in part on the age of the data and/or recent use in accordance with temporal locality. In addition, the processor may implement a cache coherency mechanism or protocol to help ensure that data in the caches is coherently managed and written back to the system memory at appropriate times so that all cores, processors, or other entities in the system coherently view correct and current versions of the data. Examples of suitable cache coherency protocols include, but are not limited to, MESI, MOSI, MOESI, and the like. The MESI protocol includes four states, namely modified (M), exclusive (E), shared (S), and invalid (I), which are indicated by two MESI bits. The MOSI protocol utilizes the owned (O) state in place of the exclusive (E) state. The MOESI protocol utilizes both the exclusive (E) and owned (O) states. The modified state designates a dirty cache line.

In order for the caches to be most effective, it is generally important to keep them filled with relevant data that is likely to be needed in the near future. For example, if the first core 103-1 is to perform an instruction, it can generally perform the instruction right away if the instruction has already been stored in the cache hierarchy 115 in advance, whereas the performance of the instruction may be delayed if instead the instruction had not already been stored in the cache hierarchy and instead needs to be loaded from the system memory 102 at the time when the first core 103-1 has resources and is ready to perform the first instruction. Similarly, if the first core is to perform an instruction on a given data, it can generally perform the instruction right away if both the instruction and the given data have already been stored in the cache hierarchy in advance, whereas the performance of the instruction may be delayed if either the instruction and/or the given data had not already been stored in the cache hierarchy and instead need to be loaded from the system memory at the time when they are needed. Accordingly, non-optimal use of the caches may tend to create conditions where the processor is ready to perform work, and has time and resources and availability to perform the work, but may be stalled waiting on instructions and/or their data to be retrieved from the system memory. Such conditions generally tend to represent an inefficient use of processor resources, and may tend to degrade performance. Fortunately, in many cases it is possible to know ahead of time (e.g., by a programmer and/or a compiler or other software) what instructions and/or data are needed.

Referring again to FIG. 1, the instruction set 104 of the first core 103-1 may include one or more instructions 105, 106, 107 to load data and/or instructions into the caches of the processor. By way of example, a programmer and/or a compiler may include one or more of these different types of instruction in a program in order to load data and/or instructions into the caches before the data and/or instructions are actually needed. Often, the data and/or instructions may be loaded into the caches just before they are actually needed, so that it doesn't unnecessarily occupy the caches for a long residency and/or age and get evicted before being used. When used in this way, such instructions may help to put data and/or instructions in the caches before the data and/or instructions are needed. This may help to avoid, or at least reduce, the number of cache misses, which in turn may help to improve processor performance and/or throughput.

The instruction set may include an embodiment of a fetch instruction 106. In addition, in some embodiments, the instruction set may optionally include a load instruction 105 and/or may optionally include a prefetch instruction 107. Each of these three different types of instructions may perform loads differently and/or may offer different possible advantages under different situations.

In some embodiments, the load instruction 105 may indicate data 117 in the system memory, and may not specify or specifically indicate a cache level in the cache hierarchy 115. The load instruction 105 when performed may be operative to cause the processor to load the indicated data 117 from the system memory 102, and store the loaded data as data 110 that has been loaded by the load instruction 105 in the architectural registers 109 of the executing core. The load instruction 105 when performed may also be operative to cause the processor to store the loaded data as data 121 that has been loaded by the load instruction 105 in the cache hierarchy (e.g., in this case in the L3 cache 114) but not at any specified or specifically indicated cache level in the cache hierarchy. In some embodiments, the load instruction may be architecturally guaranteed to be performed and completed. For example, the load corresponding to the load instruction may be treated by the processor as a so-called demand load that has high priority and that the processor cannot ordinarily decide not to perform or complete.

In some embodiments, the prefetch instruction 107 may indicate data 117 in the system memory, may specify or otherwise indicate a given cache level (e.g., in this specific example the level corresponding to the L2 cache 113) in the cache hierarchy 115, and may be treated by the processor as an architectural hint and/or may not be architecturally guaranteed to be performed and/or completed. In some cases, if performed and completed, the prefetch instruction may be operative to cause the processor to load the indicated data 117 from the system memory 102, and store the loaded data as data 120 that has been loaded by the prefetch instruction 107 in a given cache at the indicated given cache level (e.g., in this specific example the level corresponding to the L2 cache 113). In contrast to the load instruction 105, the prefetch instruction 107, if performed and completed, may not be operative to cause the processor to store the loaded data in the architectural registers 109 of the executing core.

However, in other cases, the prefetch instruction 107 may not be performed and/or may not be completed. As previously mentioned, the prefetch instruction may represent an architectural hint and/or may not be architecturally guaranteed to be performed and/or completed. The hint may suggest to the processor that loading the indicated data may be desirable, but the processor may not be architecturally bound or required to actually load the indicated data. Rather, the processor may be architecturally free or allowed to decide whether or not it wants to perform and complete the prefetch instruction. For example, the processor may be able to make this decision based on various factors, such as, for example, current workload, resources available, whether the processor has something else it wants to do instead, whether time and/or resources are needed instead for demand loads, etc. In some cases, the processor (e.g., one of its memory subsystem components) may deliberately decide or determine not to perform and/or complete the prefetch instruction. As one example, as shown at 118, the memory controller 116 may determine to drop the prefetch instruction (e.g., remove an operation corresponding to the prefetch instruction from its buffers, perform the prefetch instruction as a no operation NOP), etc.). Accordingly, the load for the prefetch instruction may have a lower priority than a demand load and may not be architecturally guaranteed to be performed or completed.

In some embodiments, the fetch instruction 106 may indicate data 117 in the system memory (e.g., provide address information to indicate potentially combined with other information a memory location), and may specify or otherwise indicate a given cache level. In this specific example the indicated level is that corresponding to the L3 cache 114, but in other examples any other desired cache level in the cache hierarchy 115 may optionally be indicated. The fetch instruction 106 when performed may be operative to cause the processor to load the indicated data 117 from the system memory 102, and store the loaded data as data 121 that has been loaded by the fetch instruction 106 in a given cache at the indicated given cache level (e.g., in this specific example the level corresponding to the L3 cache 114, but in other examples any other desired cache level). The fetch instruction may bring data into the indicated cache level from memory or higher level cache levels. However, in contrast to the load instruction 105, the fetch instruction 106, when performed may not cause the processor to store the loaded data in the architectural registers 109 of the executing core. Advantageously, this may potentially allow data to be loaded into the cache hierarchy before it is actually needed without loading that data into the architectural registers, which could tend to tie up the generally limited space in the architectural registers especially when the data is loaded in advance of when it is actually needed.

In contrast to the prefetch instruction 107, and similar to the load instruction 105, the fetch instruction 106, may be architecturally guaranteed to be performed and completed. As used herein, an instruction or operation being architecturally guaranteed to complete means that the processor is not architecturally flexible to decide at its own discretion whether or not to complete the instruction or operation (e.g., it is not an architectural hint that the processor may freely decide not to complete). In some embodiments, the load corresponding to the fetch instruction 106 may be architecturally guaranteed to be treated by the processor as one that the processor cannot decide or ordinarily decide on its own discretion not to perform and/or not to complete. In some embodiments, the load corresponding to the fetch instruction 106 may be treated by the processor as having a higher priority than a load corresponding to the prefetch instruction 107. In some embodiments, the load corresponding to the fetch instruction 106 may be treated by the processor as having the same or a substantially similar priority as a load corresponding to the load instruction 105. In some embodiments, the load corresponding to the fetch instruction 106 may be treated by the processor as a so-called demand load that has a very high priority or a highest priority similar to or the same as the priority of a load corresponding to the load instruction 105. Now, at certain times a system crash, a system reboot, a blue screen event, a non-backed power failure, a device failure, or other such extreme conditions may potentially cause a fetch instruction not be interrupted and not to complete. Moreover, at certain times, the fetch instruction may attempt to do something that it is not permitted or allowed to do, or which it cannot do, and this may also potentially cause the fetch instruction to be interrupted and not to complete. For example, this may happen if the fetch instruction attempts to access a region of memory that it is not permitted to access, if it causes an address range violation, if it causes a segment fault, if it attempts a privilege violation, or the like. The term architecturally guaranteed to complete does not exclude such possibilities, but rather differently means that the processor is not architecturally free to decide on its own discretion whether or not to perform and/or complete the instruction and/or operation.

Since the prefetch instruction is not architecturally guaranteed to complete, the programmer and/or software does not have complete or guaranteed control that data will actually be loaded. With the prefetch instruction, the processor may decide to ignore the hint, and if it does then the data may not actually be loaded into the cache hierarchy. This may not accomplish what the programmer and/or software intended. Moreover, this may lead to cache misses at times when the instructions and/or data actually are needed, and the associated relatively long and potentially variable duration accesses needed to get the data from system memory. This may tend to degrade performance.

In addition, this may tend to be especially problematic for certain types of real time and/or time critical applications that need to perform actions in real time and/or within critical time periods. By way of example, such real time and/or time critical applications are often found in the areas of communications, signal processing, embedded control applications, and the like. Not being able to guarantee that the prefetch instruction actually loads data into the cache hierarchy may tend to make it hard to know or guarantee that a task can be completed within a certain amount of time (e.g., because whether or not there will be a cache miss is an unknown variable). For example, it may make it hard to know or guarantee that a task can be completed within a worst case execution time (WCET). WCET is one example of a metric often used to evaluate a systems ability to meet a real time application requirement. Without being able to guarantee that a prefetch instruction actually is completed and actually loads data into the cache hierarchy, in some cases to estimate WCET it may need to be assumed that it doesn't load the data into the cache hierarchy, which can lengthen the actual completion time.

However, the fetch instruction 106 is architecturally guaranteed to be performed and completed. Accordingly, it may safely be assumed (e.g., for purposes of WCET calculation) that the data has been loaded in the cache by the fetch instruction and that no cache miss will occur. Further, in many real-time applications such as in programmable logic controllers (PLC) the future code path and data to be accessed may be determinable in advance, which may allow fetch instructions to be used to populate the caches before the instructions and data are needed. The load operations may be guaranteed to be performed and predictable and deterministic such that WCET calculations can assume the data is actually loaded in the caches. Moreover, the fetch instruction may indicate a given cache level so it may even be assumed in some embodiments that the data has been loaded into the given indicated cache level.

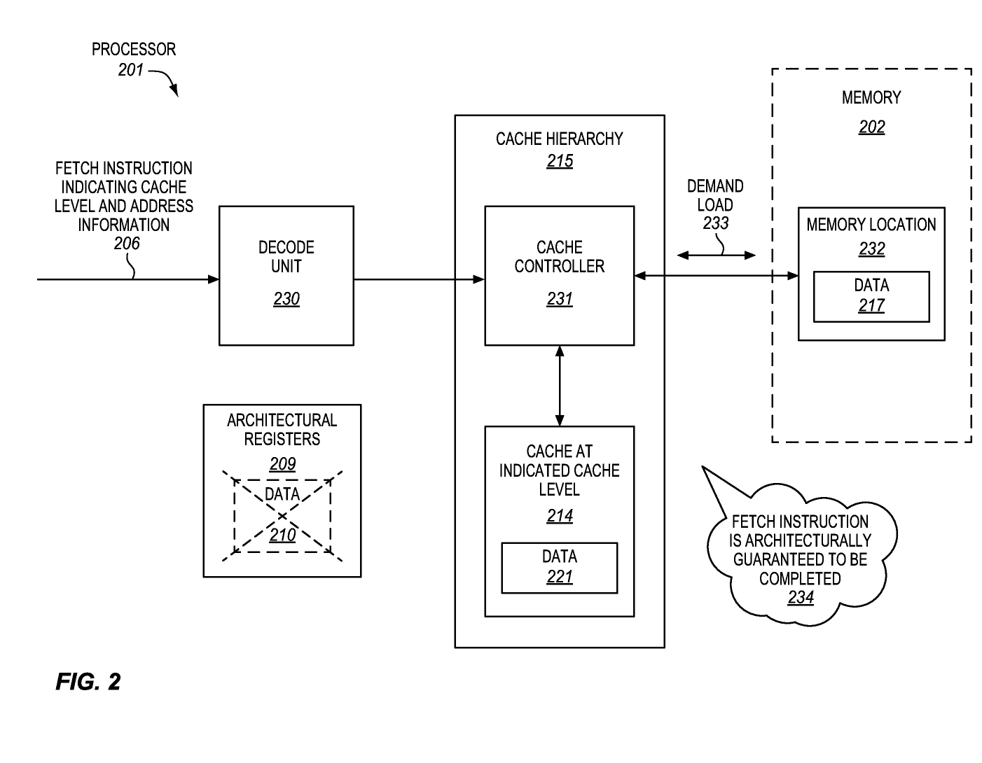

FIG. 2 is a block diagram of an embodiment of a processor 201 that is operative to perform an embodiment of a fetch instruction 206. In some embodiments, the processor may be a general-purpose processor (e.g., a general-purpose microprocessor or central processing unit (CPU) of the type used in desktop, laptop, or other computers). Alternatively, the processor may be a special-purpose processor. Examples of suitable special-purpose processors include, but are not limited to, network processors, communications processors, cryptographic processors, graphics processors, co-processors, embedded processors, digital signal processors (DSPs), and controllers (e.g., microcontrollers). The processor may have any of various complex instruction set computing (CISC) architectures, reduced instruction set computing (RISC) architectures, very long instruction word (VLIW) architectures, hybrid architectures, other types of architectures, or have a combination of different architectures (e.g., different cores may have different architectures). In various embodiments, the processor may represent at least a portion of an integrated circuit, may be included on a die or semiconductor substrate, may include semiconductor material, may include transistors, etc.

During operation, the processor 201 may receive the fetch instruction 206. For example, the instruction may be received from memory on a bus or other interconnect. The instruction may represent a macroinstruction, machine code instruction, assembly language instruction, or other instruction or control signal of an instruction set of the processor.

In some embodiments, the fetch instruction may explicitly specify (e.g., through one or more fields or a set of bits), or otherwise indicate (e.g., implicitly indicate), address information for a memory location 232 having data 217 to be loaded. The term “data” is used broadly herein to refer to either data (i.e., not instructions) and/or instructions. Various different types of address information are possible. The address information may either represent absolute memory address information or relative memory address information, which may indicate a memory location relative to a base memory address or other memory location. In addition, various different indirect memory addressing modes may optionally be used. As one specific example, the fetch instruction may implicitly indicate a register (e.g., a general-purpose register) that is used to store relative memory address information that may be combined with additional memory address information stored in another implicit register (e.g., a code, data, or extended segment register) to generate the final memory address used to identify the memory location 232 having the first byte or other data element of the data 217 to be loaded. The implicitly or impliedly indicated register(s) may be understood by the processor although unexpressed through an explicit value. For example, the processor may understand or recognize after identifying an opcode of the instruction that it is inherent or implicit to use the register(s). This is just one example. Other forms of the address information are also possible. Also, rather than the address information being provided in one or more registers, potentially some or all of the address information may be provided by bits of the instruction (e.g., an immediate).

In some embodiments, the fetch instruction may explicitly specify (e.g., through one or more fields or a set of bits), or otherwise indicate (e.g., implicitly indicate), a cache level of a plurality of different cache levels of a cache hierarchy. In some embodiments, the fetch instruction may have a cache level indication field or set of bits to provide a value to indicate a given cache level. To indicate a given cache level may include to indicate a given cache at a given cache level and/or to indicate a given cache level. As used herein, the term “field” does not imply contiguous bits, but rather encompasses separated bits that logically are grouped together into a field. Various different possible conventions may be used to map arbitrary values of the cache level indication field or set of bits to the different cache levels. For example, a first value may indicate a first cache level, a second different value may indicate a second different cache level, a third still different value may indicate a third still different cache level, and so on. In other embodiments, a cache level may be implicit to the fetch instruction (e.g., an opcode of the fetch instruction). For example, several different fetch instructions (e.g., several different fetch instruction opcodes) may be provided and each dedicated to a different corresponding cache level. For example, a first fetch instruction opcode may be dedicated to fetching indicated data to a first implicit cache level, a second different fetch instruction opcode may be dedicated to fetching indicated data to a second different implicit cache level, and so on. In some embodiments, the fetch instruction may indicate the cache level as being any one of a level one (L1) data cache, an L1 instruction cache, and a level two (L2) cache, an optional level three (L3) cache, and an optional level four (L4) cache. Alternatively, fewer or more cache levels may optionally be used.

Referring again to FIG. 2, the processor includes a decode unit or decoder 230. The decode unit may receive and decode the fetch instruction. The decode unit may output one or more relatively lower-level instructions or control signals (e.g., one or more microinstructions, micro-operations, micro-code entry points, decoded instructions or control signals, etc.), which reflect, represent, and/or are derived from the relatively higher-level fetch instruction. In some embodiments, the decode unit may include one or more input structures (e.g., port(s), interconnect(s), an interface) to receive the fetch instruction, an instruction recognition and decode logic coupled therewith to recognize and decode the fetch instruction, and one or more output structures (e.g., port(s), interconnect(s), an interface) coupled therewith to output the lower-level instruction(s) or control signal(s). The decode unit may be implemented using various different mechanisms including, but not limited to, microcode read only memories (ROMs), look-up tables, hardware implementations, programmable logic arrays (PLAs), and other mechanisms suitable to implement decode units.

In some embodiments, instead of the fetch instruction being provided directly to the decode unit, an instruction emulator, translator, morpher, interpreter, or other instruction conversion module may optionally be used. Various types of instruction conversion modules may be implemented in software, hardware, firmware, or a combination thereof. In some embodiments, the instruction conversion module may be located outside the processor, such as, for example, on a separate die and/or in a memory (e.g., as a static, dynamic, or runtime emulation module). By way of example, the instruction conversion module may receive the fetch instruction, which may be of a first instruction set, and may emulate, translate, morph, interpret, or otherwise convert the fetch instruction into one or more corresponding intermediate instructions or control signals, which may be of a second different instruction set. The one or more intermediate instructions or control signals of the second instruction set may be provided to a decode unit (e.g., decode unit 230), which may decode them into one or more lower-level instructions or control signals executable by native hardware of the processor (e.g., a cache controller and/or one or more execution units).

Referring again to FIG. 2, a cache controller 231 is coupled with the decode unit 230. The cache controller is also coupled with a cache 214 that is at the cache level indicated by the fetch instruction. The cache 214 is one of at least two different caches at two or more different cache levels of a cache hierarchy 215. In various embodiments, the cache hierarchy may include at least one L1 cache (e.g., an L1 instruction cache and an L1 data cache, or a unified L1 cache), at least one L2 cache, optionally at least one L3 cache, and optionally at least one L4 cache. The cache controller may represent an execution unit that performs or implements the operations for the fetch instruction. The cache controller may receive the one or more decoded or otherwise converted instructions or control signals that represent and/or are derived from the fetch instruction. The cache controller may also receive the address information for a memory location and the indication of the cache level. The cache controller may be operative, in response to and/or as a result of the fetch instruction (e.g., in response to one or more instructions or control signals decoded from the instruction and/or in response to the instruction being decoded and/or in response to the instruction being provided to a decoder), to load data 217 (e.g., instructions or non-instruction data) associated with the memory location 232, and store this data into the cache 214 at the indicated cache level. In some embodiments, as will be explained further below, the fetch instruction may also specify or otherwise indicate an amount of data to be loaded, and the indicated amount of data may be loaded. Advantageously, the fetch instruction may allow software and/or a programmer to load instructions and/or non-instruction data into a desired cache level so that it is closer to the execution pipeline when later needed. This may help to prevent a cache miss and the resulting high latency of needing to access the data from memory at the time when the data is actually needed.

In some cases, the data 217 associated with the memory location may not already be stored in the caches and may be loaded from the memory location. In some embodiments, the memory address may be checked to make sure it is aligned and ensure that accesses are in complete cache line chunks and do not cross page boundaries. In other cases, the data 217 associated with the memory location may already exist in the cache hierarchy (e.g., may have been previously loaded). In such cases, if the data is in a higher level cache than the cache at the indicated cache level it may be brought into the lower level cache at the indicated cache level, or if the data already exists at the indicated cache level the cache line(s) may be “touched” to reset the age or least recently used metadata for the cache line(s) to delay eviction, or if the data is in a lower level cache than the cache at the indicated cache level it may be either allowed to remain at the lower level cache or moved to the cache at the indicated cache level. The cache controller or processor may first check the L1 cache(s), and then check the L2 cache(s), and so on up the hierarchy toward the system memory.

In some embodiments, as shown at 234, the fetch instruction 206 may be architecturally guaranteed to be performed and completed by the processor (e.g., the processor is not architecturally flexible to decide at its own discretion whether or not to perform and/or complete the fetch instruction). Advantageously, this may help to make the loads guaranteed or deterministic. In some embodiments, the load operation may be performed as a demand load 233. In some embodiments, the demand load or other load operation used to implement the fetch instruction may have a higher priority than a corresponding load operation for a prefetch instruction (e.g., which may also be decoded by the decode unit and performed by the processor) which may be treated as an architectural hint. In some embodiments, the demand load or other load operation used to implement the fetch instruction may have the same or a substantially similar priority than a corresponding load operation for a load instruction (e.g., which may also be decoded by the decode unit and performed by the processor) used to load data into architectural registers of the processor.

In some embodiments, as shown generally by the cross through data 210, the processor may complete performance of the fetch instruction without storing the loaded data associated with the memory location in any architectural registers 209 of the processor. In some embodiments, even though the load operation may be performed as the demand load 233, which may have a same or similar priority as a load that is used to load data into architectural registers of the processor (e.g., general-purpose registers, packed data registers, etc.) for immediate processing, the fetch instruction when performed may not load the data into the architectural registers. Such architectural registers generally represent valuable and scarce storage space, and generally should not be consumed until actually needed. In some embodiments, the fetch instruction may be used to bring the data into the caches before the data actually needs to be processed in order to hide some of the generally long latency of accessing the data from memory. Once the data has been brought into the caches, a relatively low latency load operation may subsequently be performed to load the data into the architectural registers right when the data actually needs to be processed.

In some embodiments, the fetch instruction may optionally be retired or otherwise committed (e.g., by a commit unit, now shown) before the data is actually stored into the cache at the indicated level, although this is not required. The fetch instruction may set up or establish the load that is to be performed, and then proceed to retire or commit while the load operation progresses toward completion. At least conceptually, the fetch instruction when performed may set up or configure a direct memory access (DMA) operation or DMA engine (e.g., at the implicated cache controller) to load data into the cache at the indicated cache level.

The cache controller and/or the processor may include specific or particular logic (e.g., transistors, integrated circuitry, or other hardware potentially combined with firmware (e.g., instructions stored in non-volatile memory) and/or software) that is operative to perform the fetch instruction and/or store the data in the indicated cache level in response to and/or as a result of the fetch instruction (e.g., in response to one or more instructions or control signals decoded from the fetch instruction). In some embodiments, the cache controller may include one or more input structures (e.g., port(s), interconnect(s), an interface) to receive the data, circuitry or logic coupled therewith to process the data, and one or more output structures (e.g., port(s), interconnect(s), an interface) coupled therewith to output the data to the cache.

To avoid obscuring the description, a relatively simple processor 201 has been shown and described. However, the processor may optionally include other processor components. For example, various different embodiments may include various different combinations and configurations of the components shown and described for any of Figures xx-xx. All of the components of the processor may be coupled together to allow them to operate as intended.

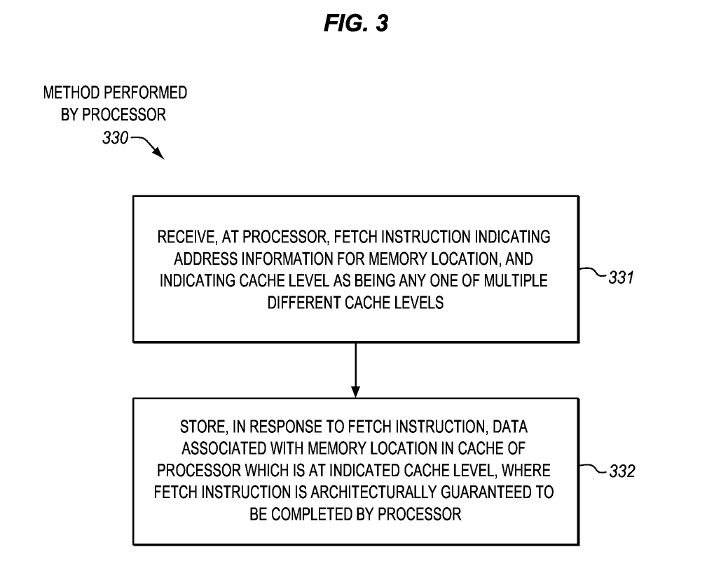

FIG. 3 is a block flow diagram of an embodiment of a method 330 of performing an embodiment of a fetch instruction. In various embodiments, the method may be performed by a processor, instruction processing apparatus, digital logic device, or integrated circuit. In some embodiments, the method of FIG. 3 may be performed by and/or within the processor of FIG. 2. The components, features, and specific optional details described herein for the processor of FIG. 2, also optionally apply to the method of FIG. 3. Alternatively, the method of FIG. 3 may be performed by and/or within a similar or different processor or apparatus. Moreover, the processor of FIG. 2 may perform methods the same as, similar to, or different than those of FIG. 3. In some embodiments, the method may optionally be performed as part of and/or while performing a real time application with the processor, which may optionally be a general-purpose central processing unit (CPU) or other general-purpose processor, although the scope of the invention is not so limited.

The method includes receiving the fetch instruction at the processor, at block 331. In various aspects, the instruction may be received at a processor or a portion thereof (e.g., an instruction fetch unit, a decode unit, a bus interface unit, etc.). In various aspects, the instruction may be received from an off-processor and/or off-die source (e.g., from memory, interconnect, etc.), or from an on-processor and/or on-die source (e.g., from an instruction cache, instruction queue, etc.). The fetch instruction may specify or otherwise indicate address information for a memory location. The previously mentioned forms of address information are suitable. The fetch instruction may also specify or otherwise indicate a cache level as being any one of a plurality of different cache levels. In some embodiments, the fetch instruction may be able to indicate alternatively either an L1 instruction cache or an L1 data cache, as well as other levels of cache. In some embodiments, the fetch instruction may also optionally specify or otherwise indicate an amount of the data to be loaded.

The method also includes storing, in response to and/or as a result of the fetch instruction, data associated with the memory location in a cache of the processor that is at the indicated cache level, at block 332. In some embodiments, the processor may complete performance of the fetch instruction without storing the data associated with the memory location in any architectural registers of the processor. In some embodiments, the fetch instruction may be architecturally guaranteed to be completed by the processor. In some embodiments, the fetch instruction may be performed through a demand load, which may have a same or substantially the same priority as demand loads used to load data into the architectural registers of the processor for immediate processing, and which may have a higher priority than a load operation used to perform a prefetch instruction which is an architectural hint and is not architecturally guaranteed to complete.

The illustrated method involves architectural operations (e.g., those visible from a software perspective). In other embodiments, the method may optionally include one or more microarchitectural operations. By way of example, the instruction may be fetched, decoded, scheduled out-of-order, source operands may be accessed, an execution unit may perform microarchitectural operations to implement the instruction, etc. In some embodiments, the microarchitectural operations to implement the instruction may optionally include using the indicated address information to generate a full memory address that may be used to access the data from system memory. In some embodiments, the microarchitectural operations to implement the instruction may also optionally include checking to make sure the memory address is aligned and ensuring that accesses are in complete cache line chunks and do not cross page boundaries (e.g., to help avoid generating page faults). The microarchitectural operations to implement the instruction may also optionally include loading the data from the system memory (e.g., transmitting the data over a bus or other interconnect, etc.).

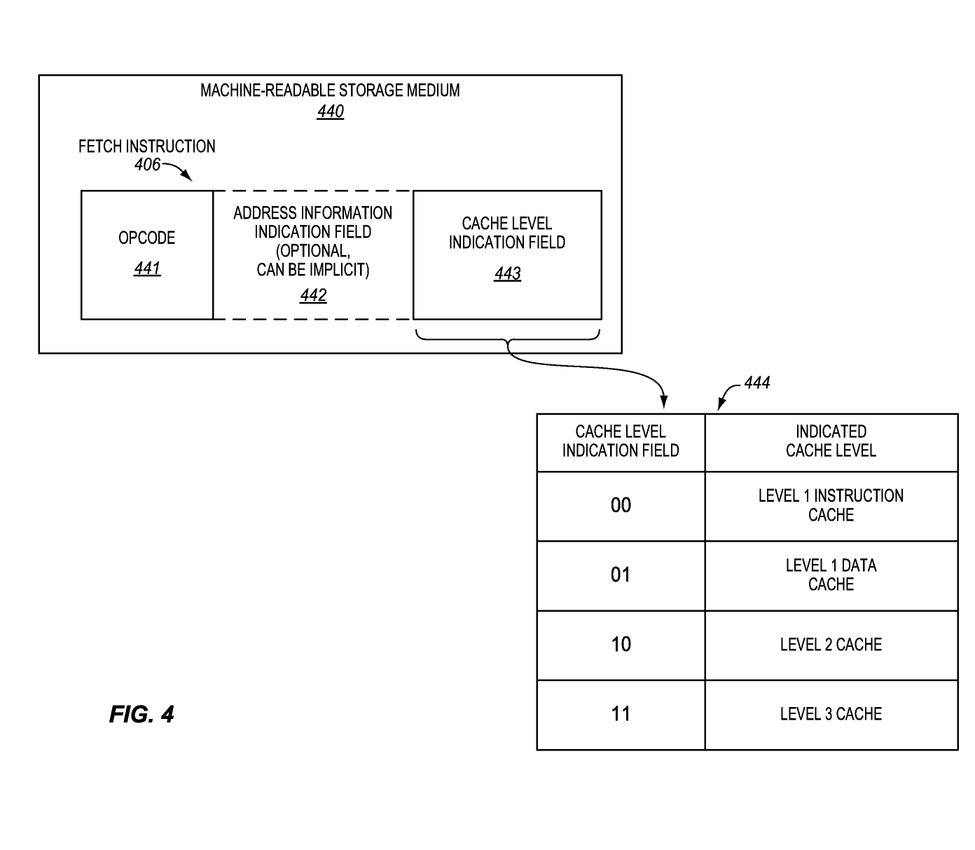

FIG. 4 is a block diagram of a first example embodiment of a fetch instruction 406. The fetch instruction is stored or otherwise provided on a machine-readable medium 440. The medium may include a mechanism that provides, for example stores, information in a form that is readable by a computer system or other machine. The machine-readable medium may provide, or have stored thereon, the fetch instruction, and the fetch instruction if and/or when performed by the computer system or other machine may be operative to cause the machine to perform and/or result in the machine performing one or operations, methods, or techniques disclosed herein.

The fetch instruction includes an operation code or opcode 441. The opcode may represent a plurality of bits, or one or more fields, that are operative to identify the instruction and/or the operation to be performed (e.g., a fetch operation). The instruction also includes an optional address information indication field 442 to indicate address information. By way of example, the optional address information indication field may include bits to specify an address of a register, memory location, or other storage location where the address information is to be stored. Alternatively, the optional address information indication field (e.g., an immediate) may provide the address information directly instead of indirectly through a register or other storage location. As a still further example, the address information indication field may optionally be omitted, and instead of having this field it may be implicit or inherent to the fetch instruction (e.g., to the opcode 441) that the address information is stored in a given register or other storage location. For example, the processor may understand or recognize after identifying the opcode that it is inherent or implicit, although unexpressed, to read the address information from a certain fixed register.

The instruction also has a cache level indication field 443. The cache level indication field may provide a value to specify or otherwise indicate a cache level where loaded data is to be stored. The particular mapping of the values and the associated cache levels is arbitrary and many different conventions may optionally be adopted. The cache level indication field may have two bits, three bits, four bits, or optionally more bits, depending upon the number of cache levels desired to be indicated and other possible options to be specified or indicated. Alternatively, instead of providing the value directly, the cache level indication field may optionally indicate a register or other storage location that may be used to store the value to indicate the cache level.

To further illustrate certain concepts, a table 444 illustrates one suitable example of a mapping of different 2-bit cache level indication field values to different indicated cache levels, although this is just one possible example and the scope of the invention is not limited to this specific example. According to this specific example, a 2-bit value of ‘00’ indicates an L1 instruction cache, a value of ‘01’ indicates an L1 data cache, a value of ‘10’ indicates an L2 cache, and a value of ‘11’ indicates an L3 cache. It is to be appreciated that this is just one illustrative example.

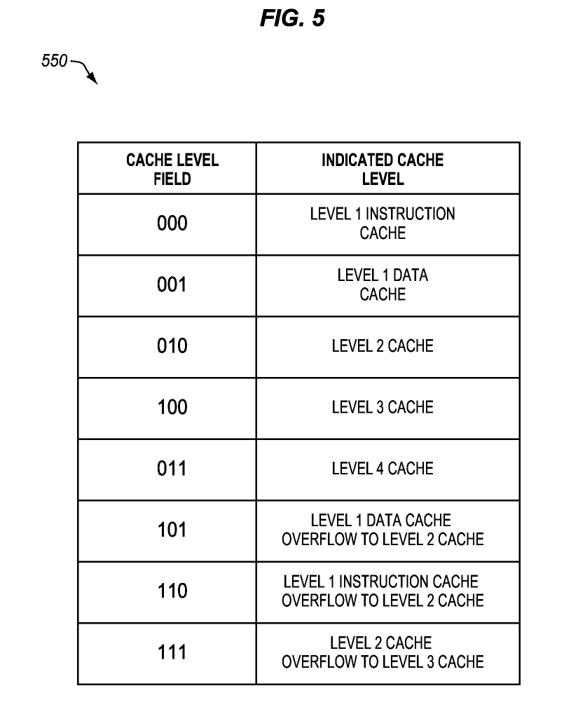

FIG. 5 is a table 550 illustrating a suitable example of a mapping of different 3-bit cache level indication field values to different indicated cache levels. This is just one specific example and the scope of the invention is not limited to this specific example. According to this specific example, a 3-bit value of ‘000’ indicates an L1 instruction cache, a value of ‘001’ indicates an L1 data cache, a value of ‘010’ indicates an L2 cache, and a value of ‘100’ indicates an L3 cache. Continuing, a value of ‘011 indicates an L4 cache, a value of ‘101 indicates an L1 data cache with overflow allowed to an L2 cache, a value of ‘110 indicates an L2 instruction cache overflow allowed to an L2 cache, and a value of ‘111 indicates an L2 cache with overflow allowed to an L3 cache. It is to be appreciated that this is just one illustrative example. In this example, more different possible combinations of 3-bit values are available than different cache levels, and so some of the available combinations of 3-bit values are used to indicate additional information (e.g., in this case that overflow to a higher level cache is allowed).

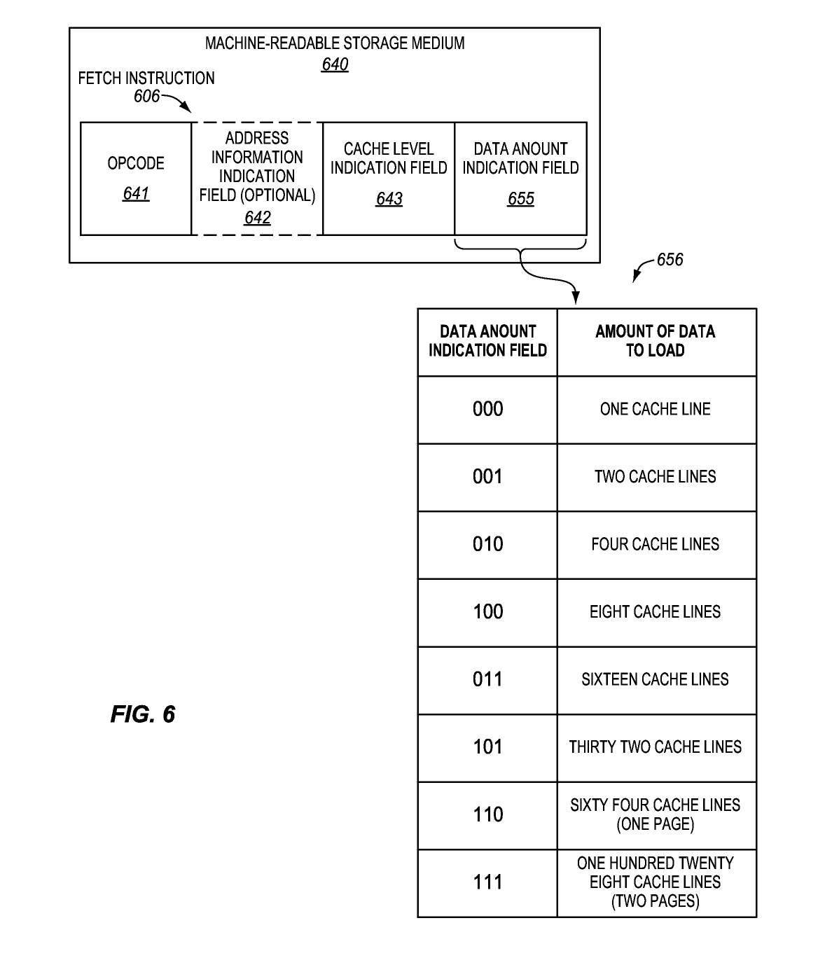

FIG. 6 is a block diagram of a second example embodiment of a fetch instruction 606. The fetch instruction is stored or otherwise provided on a machine-readable medium 640. The fetch instruction includes an opcode 641, an optional address information indication field 642, and a cache level indication field 643. Unless otherwise specified, these may optionally have some or all of the characteristics of the correspondingly named opcode and fields of the fetch instruction of FIG. 4. To avoid obscuring the description, the different and/or additional characteristics will primarily be described without repeating the common characteristics.

The fetch instruction also includes an optional data amount indication field 655. The data amount indication field may provide a value to specify or otherwise indicate an amount of data to be loaded and stored to a cache at the indicated cache level. The particular mapping of the values and the associated amounts of data is arbitrary, and many different conventions may optionally be adopted. The data amount indication field may have two bits, three bits, four bits, five bits, six bits, or optionally more bits, depending upon the number of different amounts of data desired to be indicated and/or other possible options to be specified or indicated. In some embodiments, at least four different amounts of data may be specified. In some embodiments, the amount of data may range from a single cache line worth of data (e.g., 512-bits), to a maximum number of cache lines that fit within a single page (e.g., sixty four cache lines may fit within a four kilobyte page), or optionally in some embodiments up to several pages of memory.

To further illustrate certain concepts, a table 656 illustrates one suitable example of a mapping of different 3-bit data amount indication field values to different examples of amounts of data to be loaded. This is just one specific example and the scope of the invention is not limited to this specific example. According to this specific example, a 3-bit value of ‘000’ indicates one (i.e., a single) cache line, a value of ‘001’ indicates two contiguous cache lines, a value of ‘010’ indicates four contiguous cache lines, and a value of ‘100’ indicates eight contiguous cache lines. Continuing, a value of ‘011 indicates sixteen contiguous cache lines, a value of ‘101 indicates thirty two contiguous cache lines, a value of ‘110 indicates sixty four contiguous cache lines (e.g., a single four kilobyte page worth of cache lines), and a value of ‘111 indicates one hundred twenty eight contiguous cache lines (e.g., two contiguous four kilobyte pages worth of cache lines). It is to be appreciated that this is just one illustrative example. For example, in other embodiments, instead of indicating multiple pages (e.g., which could potentially lead to page faults), other numbers of contiguous cache lines (e.g., three contiguous cache lines or six contiguous cache lines) may instead be indicated. In other embodiments, there may be an option to select more than two pages. Moreover, different distributions and/or spacing of cache lines may optionally be used.

In the illustrated example embodiment, the values of the data amount indication field 655 correspond to fixed amounts of data as shown in table 656, although this is not required. In other embodiments, the fetch instruction of FIG. 6 may optionally include a data granularity field (e.g., one or more bits) to indicate a data granularity for the value indicated in the data amount indication field 655. For example, the data granularity field may indicate whether the value provided in the data amount indication field 655 is at cache line granularity (e.g., expresses or selects a number of cache lines), or is at page granularity (e.g., expresses or selects a number of pages). By way of example, the value of “100” in the data amount indication field 655 may indicate that eight units are to be loaded, and the data granularity field may have either a first value to indicate that these units are cache lines, or a second different value to indicate that these units are pages. Such a data granularity field may optionally be used with any of the other embodiments of the fetch instructions disclosed herein.

The ability to load multiple cache lines by performing a single instruction may help to reduce the number of instructions (e.g., instruction bloat) in code and/or may help to reduce the number of instructions that need to be performed, which may help to improve execution performance. For example, the instruction may have a fixed overhead of executing a single instruction to load all of the different amounts of data described above. By way of example, a single fetch instruction may be used to load an entire library function that will soon be executed into an L1 instruction cache. In some cases, however, good or optimal performance may be achieved by leaving some gaps between fetched cache lines if an autonomous hardware prefetch unit of the processor is available, since such a hardware prefetch unit may be able to load intervening non-fetched cache lines opportunistically without executing instructions. However, in cases where it is important to guarantee that cache lines are loaded, such fetches from a hardware prefetch unit may, in some implementations, also not be architecturally guaranteed to be performed and/or complete.

FIGS. 4 and 6 show examples of the types of fields that may be included in a fetch instruction for some embodiments. The illustrated arrangement of the fields is not required, rather the fields may be rearranged variously. Each of the fields may either consist of a contiguous set of bits, or may include non-contiguous or separated bits that logically represent the field. Alternate embodiments may include a subset of the illustrated fields and/or may add additional fields. As one example, in some embodiments, the fetch instruction of FIG. 4 and/or of FIG. 6 may optionally include a field (e.g., one or more bits) to indicate whether or not the data will be modified or just read without modification. By way of example, software may configure the field if it knows whether the data will be modified or just read without modification. In one aspect, the processor (e.g., a cache controller) may use this field to determine or help determine a state for the loaded cache line(s) when they are stored in the cache at the indicated cache level. For example, if the field indicates that the data is to be modified, then the cache line(s) may be given a state of owned (O) in the case of the MOSI protocol or the state of exclusive (E) in the case of the MESI protocol, whereas if the field indicates that the data is to be read only without modification, then the cache line(s) may be given a state of shared (S) in the MESI and MOSI protocols. This field may optionally be used with any of the other embodiments of the fetch instructions disclosed herein.

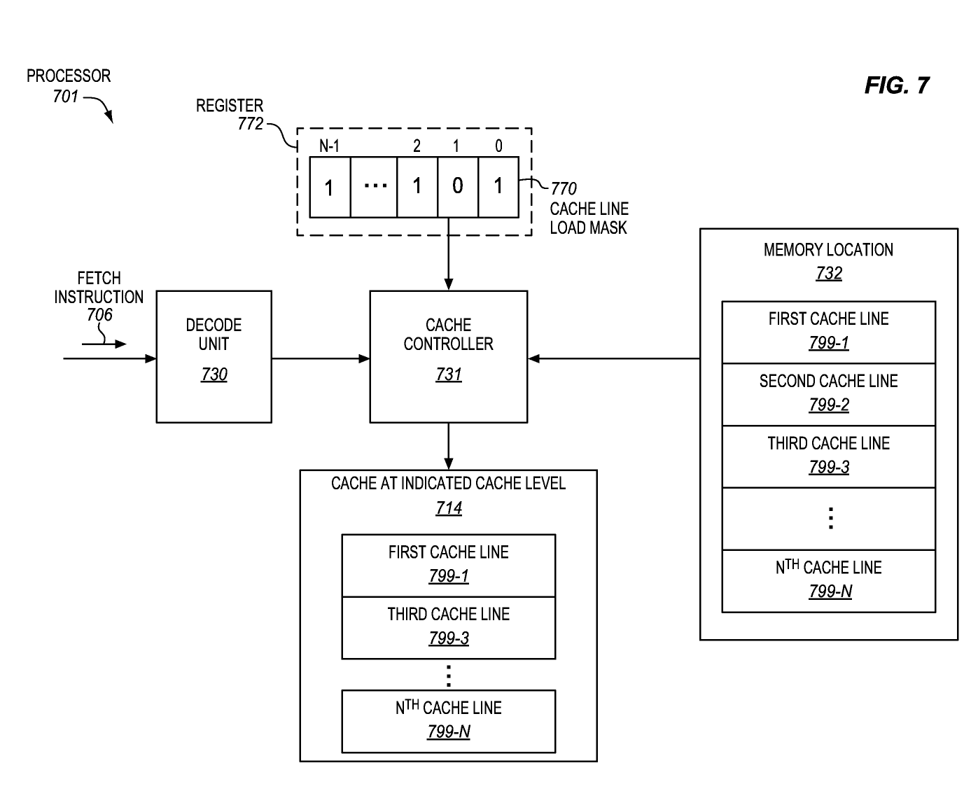

FIG. 7 is a block diagram of an example embodiment of a processor 701 that is operative to perform an embodiment of a fetch instruction 706. The processor 701 may be, or may be included in, the processor 201 of FIG. 2. The processor 701 includes a decode unit 730, a cache controller 731, and a cache 714 at a cache level indicated by the fetch instruction 706. Unless otherwise specified, these components may optionally have some or all of the characteristics of the correspondingly named components of FIG. 2. To avoid obscuring the description, the different and/or additional characteristics will primarily be described without repeating the common characteristics.

The fetch instruction 706 may specify or otherwise indicate a cache line load mask 770. The cache line load mask may optionally be stored in a register 772, such as, for example, a 32-bit or 64-bit general purpose register, a dedicated mask register used for packed data predication, or the like. Alternatively, the cache line load mask may optionally be stored in another storage location. In some embodiments, the cache line load mask may include multiple mask bits or other mask elements that may each correspond to a different cache line. The mask elements may either be masked to indicate that a corresponding cache line is not to be loaded, or unmasked to indicate that the corresponding cache line is to be loaded. For example, a mask bit may either be cleared to binary zero to indicate that the corresponding cache line is not to be loaded, or set to binary one to indicate that the corresponding cache line is to be loaded.

The cache controller, responsive to the fetch instruction, may be operative to selectively load cache lines 799 from a memory location 732 indicated by the fetch instruction according to control provided by the cache line load mask 770. For example, as shown in the specific example illustrated, bit-0 of the cache line load mask is set to binary one, and so the first cache line 799-1 may be loaded and stored in the cache 714. In contrast, bit-1 of the cache line load mask is cleared to binary zero, and so the second cache line 799-2 may be loaded or stored in the cache. Continuing, bit-2 of the cache line load mask is set to binary one, and so the third cache line 799-3 may be loaded and stored in the cache. Similarly, bit-(N−1) of the cache line load mask is set to binary one, and so the Nth cache line 799-N may be loaded and stored in the cache. In this way, the fetch instruction may indicate a number of cache lines (e.g., a contiguous range of cache lines), and the cache line load mask may be configured to select any desired pattern or arrangement of these cache lines to load or not load the cache lines on a cache line-by-cache line basis. As one example, a cache line load mask with a value of “1010101010101010” may be used to load every other cache line in a block of sixteen cache lines. By way of example, this pattern may potentially be used to leverage a hardware prefetch unit automatically loading the non-loaded cache lines. As another example, a cache line load mask with a value of “11001100110011001100110011001100” may be used to load pairs of contiguous cache lines without loading interleaved pairs of contiguous cache lines.

Exemplary Core Architectures, Processors, and Computer Architectures

Processor cores may be implemented in different ways, for different purposes, and in different processors. For instance, implementations of such cores may include: 1) a general purpose in-order core intended for general-purpose computing; 2) a high performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput). Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip that may include on the same die the described CPU (sometimes referred to as the application core(s) or application processor(s)), the above described coprocessor, and additional functionality. Exemplary core architectures are described next, followed by descriptions of exemplary processors and computer architectures.

Exemplary Core Architectures

In-Order and Out-of-Order Core Block Diagram

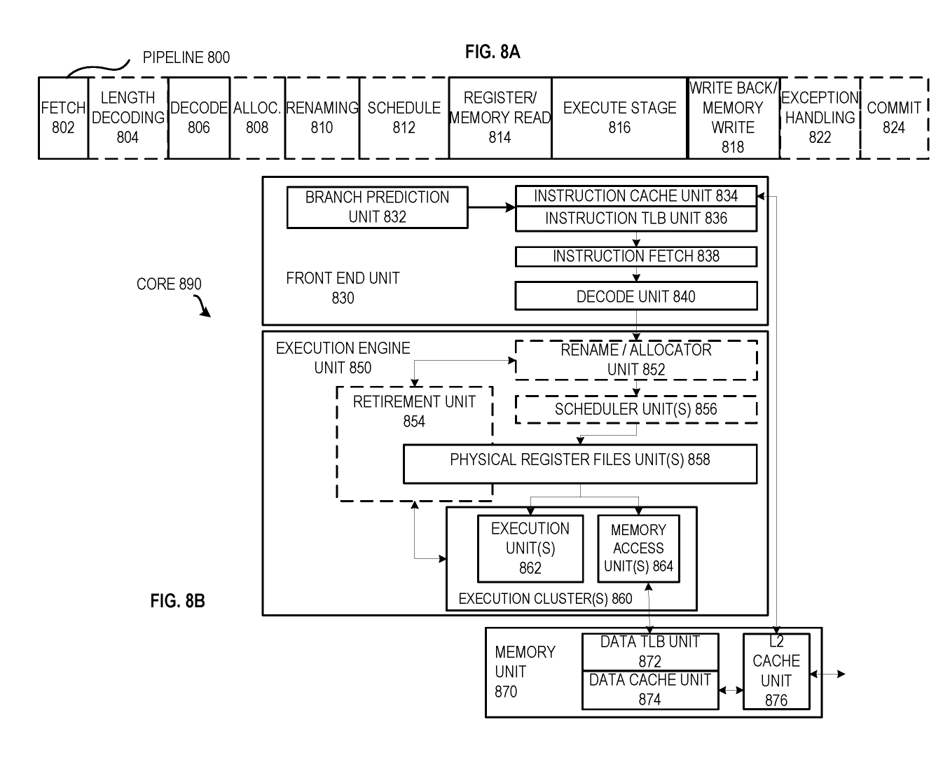

FIG. 8A is a block diagram illustrating both an exemplary in-order pipeline and an exemplary register renaming, out-of-order issue/execution pipeline according to embodiments of the invention. FIG. 8B is a block diagram illustrating both an exemplary embodiment of an in-order architecture core and an exemplary register renaming, out-of-order issue/execution architecture core to be included in a processor according to embodiments of the invention. The solid lined boxes in FIGS. 8A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 8A, a processor pipeline 800 includes a fetch stage 802, a length decode stage 804, a decode stage 806, an allocation stage 808, a renaming stage 810, a scheduling (also known as a dispatch or issue) stage 812, a register read/memory read stage 814, an execute stage 816, a write back/memory write stage 818, an exception handling stage 822, and a commit stage 824.

FIG. 8B shows processor core 890 including a front end unit 830 coupled to an execution engine unit 850, and both are coupled to a memory unit 870. The core 890 may be a reduced instruction set computing (RISC) core, a complex instruction set computing (CISC) core, a very long instruction word (VLIW) core, or a hybrid or alternative core type. As yet another option, the core 890 may be a special-purpose core, such as, for example, a network or communication core, compression engine, coprocessor core, general purpose computing graphics processing unit (GPGPU) core, graphics core, or the like.

The front end unit 830 includes a branch prediction unit 832 coupled to an instruction cache unit 834, which is coupled to an instruction translation lookaside buffer (TLB) 836, which is coupled to an instruction fetch unit 838, which is coupled to a decode unit 840. The decode unit 840 (or decoder) may decode instructions, and generate as an output one or more micro-operations, micro-code entry points, microinstructions, other instructions, or other control signals, which are decoded from, or which otherwise reflect, or are derived from, the original instructions. The decode unit 840 may be implemented using various different mechanisms. Examples of suitable mechanisms include, but are not limited to, look-up tables, hardware implementations, programmable logic arrays (PLAs), microcode read only memories (ROMs), etc. In one embodiment, the core 890 includes a microcode ROM or other medium that stores microcode for certain macroinstructions (e.g., in decode unit 840 or otherwise within the front end unit 830). The decode unit 840 is coupled to a rename/allocator unit 852 in the execution engine unit 850.

The execution engine unit 850 includes the rename/allocator unit 852 coupled to a retirement unit 854 and a set of one or more scheduler unit(s) 856. The scheduler unit(s) 856 represents any number of different schedulers, including reservations stations, central instruction window, etc. The scheduler unit(s) 856 is coupled to the physical register file(s) unit(s) 858. Each of the physical register file(s) units 858 represents one or more physical register files, different ones of which store one or more different data types, such as scalar integer, scalar floating point, packed integer, packed floating point, vector integer, vector floating point, status (e.g., an instruction pointer that is the address of the next instruction to be executed), etc. In one embodiment, the physical register file(s) unit 858 comprises a vector registers unit, a write mask registers unit, and a scalar registers unit. These register units may provide architectural vector registers, vector mask registers, and general purpose registers. The physical register file(s) unit(s) 858 is overlapped by the retirement unit 854 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement unit 854 and the physical register file(s) unit(s) 858 are coupled to the execution cluster(s) 860. The execution cluster(s) 860 includes a set of one or more execution units 862 and a set of one or more memory access units 864. The execution units 862 may perform various operations (e.g., shifts, addition, subtraction, multiplication) and on various types of data (e.g., scalar floating point, packed integer, packed floating point, vector integer, vector floating point). While some embodiments may include a number of execution units dedicated to specific functions or sets of functions, other embodiments may include only one execution unit or multiple execution units that all perform all functions. The scheduler unit(s) 856, physical register file(s) unit(s) 858, and execution cluster(s) 860 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which only the execution cluster of this pipeline has the memory access unit(s) 864). It should also be understood that where separate pipelines are used, one or more of these pipelines may be out-of-order issue/execution and the rest in-order.

The set of memory access units 864 is coupled to the memory unit 870, which includes a data TLB unit 872 coupled to a data cache unit 874 coupled to a level 2 (L2) cache unit 876. In one exemplary embodiment, the memory access units 864 may include a load unit, a store address unit, and a store data unit, each of which is coupled to the data TLB unit 872 in the memory unit 870. The instruction cache unit 834 is further coupled to a level 2 (L2) cache unit 876 in the memory unit 870. The L2 cache unit 876 is coupled to one or more other levels of cache and eventually to a main memory.

By way of example, the exemplary register renaming, out-of-order issue/execution core architecture may implement the pipeline 800 as follows: 1) the instruction fetch 838 performs the fetch and length decoding stages 802 and 804; 2) the decode unit 840 performs the decode stage 806; 3) the rename/allocator unit 852 performs the allocation stage 808 and renaming stage 810; 4) the scheduler unit(s) 856 performs the schedule stage 812; 5) the physical register file(s) unit(s) 858 and the memory unit 870 perform the register read/memory read stage 814; the execution cluster 860 perform the execute stage 816; 6) the memory unit 870 and the physical register file(s) unit(s) 858 perform the write back/memory write stage 818; 7) various units may be involved in the exception handling stage 822; and 8) the retirement unit 854 and the physical register file(s) unit(s) 858 perform the commit stage 824.

The core 890 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.), including the instruction(s) described herein. In one embodiment, the core 890 includes logic to support a packed data instruction set extension (e.g., AVX1, AVX2), thereby allowing the operations used by many multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in an in-order architecture. While the illustrated embodiment of the processor also includes separate instruction and data cache units 834/874 and a shared L2 cache unit 876, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor.

Specific Exemplary in-Order Core Architecture

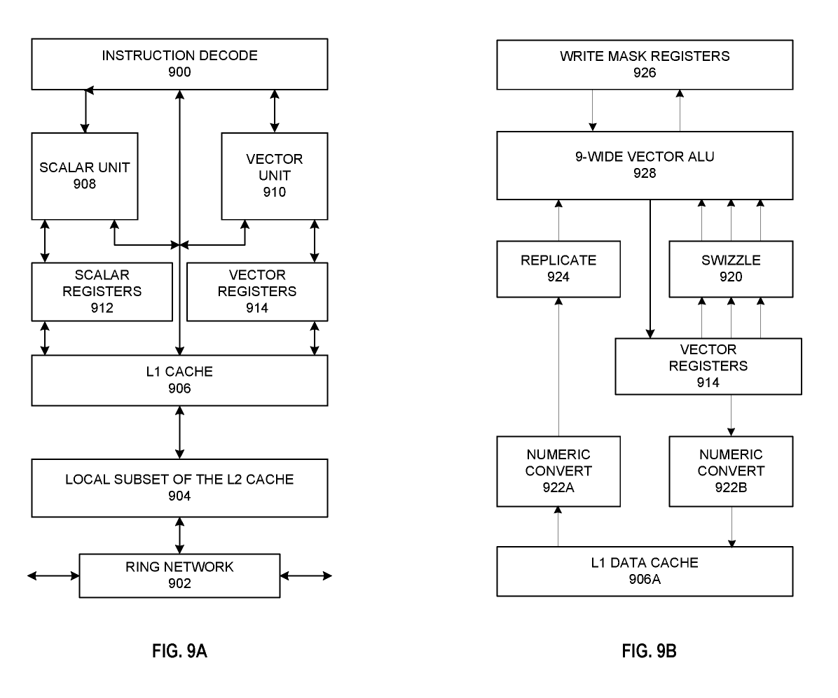

FIGS. 9A-B illustrate a block diagram of a more specific exemplary in-order core architecture, which core would be one of several logic blocks (including other cores of the same type and/or different types) in a chip. The logic blocks communicate through a high-bandwidth interconnect network (e.g., a ring network) with some fixed function logic, memory I/O interfaces, and other necessary I/O logic, depending on the application.

FIG. 9A is a block diagram of a single processor core, along with its connection to the on-die interconnect network 902 and with its local subset of the Level 2 (L2) cache 904, according to embodiments of the invention. In one embodiment, an instruction decoder 900 supports the x86 instruction set with a packed data instruction set extension. An L1 cache 906 allows low-latency accesses to cache memory into the scalar and vector units. While in one embodiment (to simplify the design), a scalar unit 908 and a vector unit 910 use separate register sets (respectively, scalar registers 1912 and vector registers 914) and data transferred between them is written to memory and then read back in from a level 1 (L1) cache 906, alternative embodiments of the invention may use a different approach (e.g., use a single register set or include a communication path that allow data to be transferred between the two register files without being written and read back).

The local subset of the L2 cache 904 is part of a global L2 cache that is divided into separate local subsets, one per processor core. Each processor core has a direct access path to its own local subset of the L2 cache 904. Data read by a processor core is stored in its L2 cache subset 904 and can be accessed quickly, in parallel with other processor cores accessing their own local L2 cache subsets. Data written by a processor core is stored in its own L2 cache subset 904 and is flushed from other subsets, if necessary. The ring network ensures coherency for shared data. The ring network is bi-directional to allow agents such as processor cores, L2 caches and other logic blocks to communicate with each other within the chip. Each ring data-path is 1012-bits wide per direction.

FIG. 9B is an expanded view of part of the processor core in FIG. 9A according to embodiments of the invention. FIG. 9B includes an L1 data cache 906A part of the L1 cache 904, as well as more detail regarding the vector unit 910 and the vector registers 914. Specifically, the vector unit 910 is a 16-wide vector processing unit (VPU) (see the 16-wide ALU 928), which executes one or more of integer, single-precision float, and double-precision float instructions. The VPU supports swizzling the register inputs with swizzle unit 920, numeric conversion with numeric convert units 922A-B, and replication with replication unit 924 on the memory input. Write mask registers 926 allow predicating resulting vector writes.

Processor with Integrated Memory Controller and Graphics

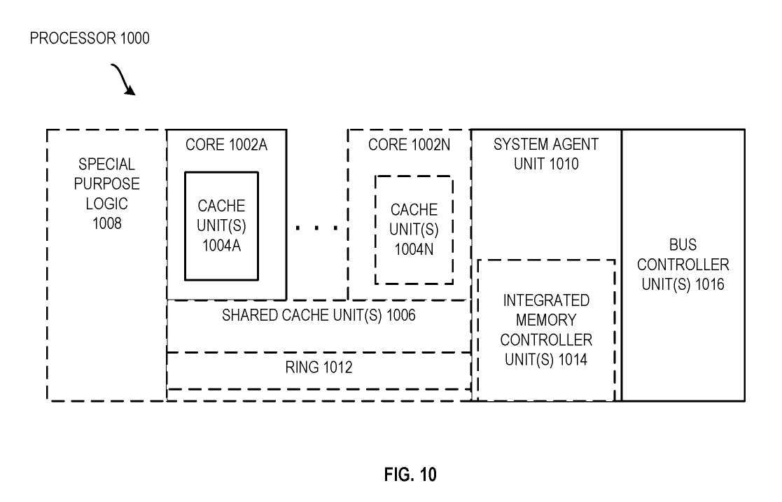

FIG. 10 is a block diagram of a processor 1000 that may have more than one core, may have an integrated memory controller, and may have integrated graphics according to embodiments of the invention. The solid lined boxes in FIG. 10 illustrate a processor 1000 with a single core 1002A, a system agent 1010, a set of one or more bus controller units 1016, while the optional addition of the dashed lined boxes illustrates an alternative processor 1000 with multiple cores 1002A-N, a set of one or more integrated memory controller unit(s) 1014 in the system agent unit 1010, and special purpose logic 1008.

Thus, different implementations of the processor 1000 may include: 1) a CPU with the special purpose logic 1008 being integrated graphics and/or scientific (throughput) logic (which may include one or more cores), and the cores 1002A-N being one or more general purpose cores (e.g., general purpose in-order cores, general purpose out-of-order cores, a combination of the two); 2) a coprocessor with the cores 1002A-N being a large number of special purpose cores intended primarily for graphics and/or scientific (throughput); and 3) a coprocessor with the cores 1002A-N being a large number of general purpose in-order cores. Thus, the processor 1000 may be a general-purpose processor, coprocessor or special-purpose processor, such as, for example, a network or communication processor, compression engine, graphics processor, GPGPU (general purpose graphics processing unit), a high-throughput many integrated core (MIC) coprocessor (including 30 or more cores), embedded processor, or the like. The processor may be implemented on one or more chips. The processor 1000 may be a part of and/or may be implemented on one or more substrates using any of a number of process technologies, such as, for example, BiCMOS, CMOS, or NMOS.

The memory hierarchy includes one or more levels of cache within the cores, a set or one or more shared cache units 1006, and external memory (not shown) coupled to the set of integrated memory controller units 1014. The set of shared cache units 1006 may include one or more mid-level caches, such as level 2 (L2), level 3 (L3), level 4 (L4), or other levels of cache, a last level cache (LLC), and/or combinations thereof. While in one embodiment a ring based interconnect unit 1012 interconnects the integrated graphics logic 1008, the set of shared cache units 1006, and the system agent unit 1010/integrated memory controller unit(s) 1014, alternative embodiments may use any number of well-known techniques for interconnecting such units. In one embodiment, coherency is maintained between one or more cache units 1006 and cores 1002-A-N.

In some embodiments, one or more of the cores 1002A-N are capable of multi-threading. The system agent 1010 includes those components coordinating and operating cores 1002A-N. The system agent unit 1010 may include for example a power control unit (PCU) and a display unit. The PCU may be or include logic and components needed for regulating the power state of the cores 1002A-N and the integrated graphics logic 1008. The display unit is for driving one or more externally connected displays.

The cores 1002A-N may be homogenous or heterogeneous in terms of architecture instruction set; that is, two or more of the cores 1002A-N may be capable of execution the same instruction set, while others may be capable of executing only a subset of that instruction set or a different instruction set.

Exemplary Computer Architectures

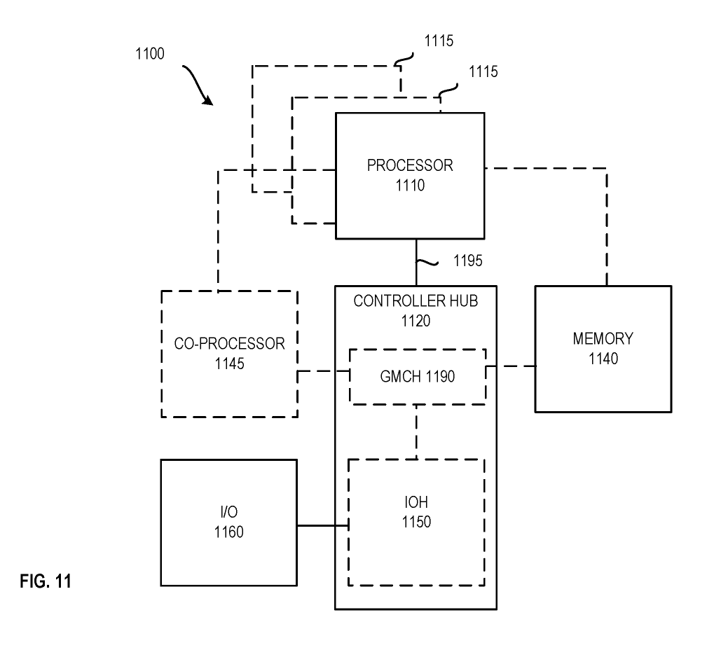

FIGS. 11-21 are block diagrams of exemplary computer architectures. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

Referring now to FIG. 11, shown is a block diagram of a system 1100 in accordance with one embodiment of the present invention. The system 1100 may include one or more processors 1110, 1115, which are coupled to a controller hub 1120. In one embodiment the controller hub 1120 includes a graphics memory controller hub (GMCH) 1190 and an Input/Output Hub (IOH) 1150 (which may be on separate chips); the GMCH 1190 includes memory and graphics controllers to which are coupled memory 1140 and a coprocessor 1145; the IOH 1150 is couples input/output (I/O) devices 1160 to the GMCH 1190. Alternatively, one or both of the memory and graphics controllers are integrated within the processor (as described herein), the memory 1140 and the coprocessor 1145 are coupled directly to the processor 1110, and the controller hub 1120 in a single chip with the IOH 1150.

The optional nature of additional processors 1115 is denoted in FIG. 11 with broken lines. Each processor 1110, 1115 may include one or more of the processing cores described herein and may be some version of the processor 1000.

The memory 1140 may be, for example, dynamic random access memory (DRAM), phase change memory (PCM), or a combination of the two. For at least one embodiment, the controller hub 1120 communicates with the processor(s) 1110, 1115 via a multi-drop bus, such as a frontside bus (FSB), point-to-point interface such as QuickPath Interconnect (QPI), or similar connection 1195.

In one embodiment, the coprocessor 1145 is a special-purpose processor, such as, for example, a high-throughput MIC processor, a network or communication processor, compression engine, graphics processor, GPGPU, embedded processor, or the like. In one embodiment, controller hub 1120 may include an integrated graphics accelerator.

There can be a variety of differences between the physical resources 1110, 1115 in terms of a spectrum of metrics of merit including architectural, microarchitectural, thermal, power consumption characteristics, and the like.

In one embodiment, the processor 1110 executes instructions that control data processing operations of a general type. Embedded within the instructions may be coprocessor instructions. The processor 1110 recognizes these coprocessor instructions as being of a type that should be executed by the attached coprocessor 1145. Accordingly, the processor 1110 issues these coprocessor instructions (or control signals representing coprocessor instructions) on a coprocessor bus or other interconnect, to coprocessor 1145. Coprocessor(s) 1145 accept and execute the received coprocessor instructions.

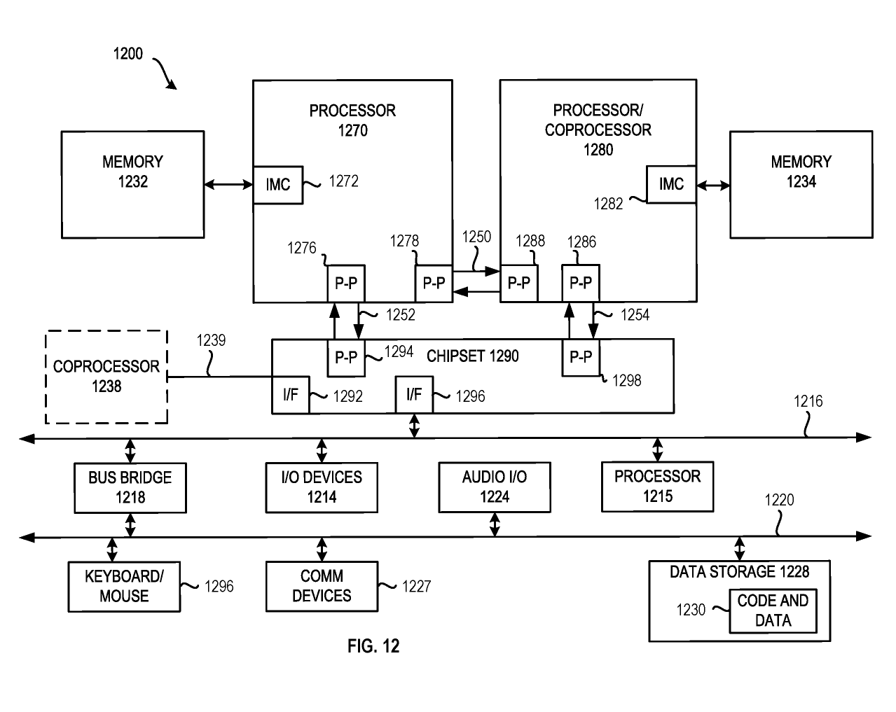

Referring now to FIG. 12, shown is a block diagram of a first more specific exemplary system 1200 in accordance with an embodiment of the present invention. As shown in FIG. 12, multiprocessor system 1200 is a point-to-point interconnect system, and includes a first processor 1270 and a second processor 1280 coupled via a point-to-point interconnect 1250. Each of processors 1270 and 1280 may be some version of the processor 1000. In one embodiment of the invention, processors 1270 and 1280 are respectively processors 1110 and 1115, while coprocessor 1238 is coprocessor 1145. In another embodiment, processors 1270 and 1280 are respectively processor 1110 coprocessor 1145.

Processors 1270 and 1280 are shown including integrated memory controller (IMC) units 1272 and 1282, respectively. Processor 1270 also includes as part of its bus controller units point-to-point (P-P) interfaces 1276 and 1278; similarly, second processor 1280 includes P-P interfaces 1286 and 1288. Processors 1270, 1280 may exchange information via a point-to-point (P-P) interface 1250 using P-P interface circuits 1278, 1288. As shown in FIG. 12, IMCs 1272 and 1282 couple the processors to respective memories, namely a memory 1232 and a memory 1234, which may be portions of main memory locally attached to the respective processors.

Processors 1270, 1280 may each exchange information with a chipset 1290 via individual P-P interfaces 1252, 1254 using point to point interface circuits 1276, 1294, 1286, 1298. Chipset 1290 may optionally exchange information with the coprocessor 1238 via a high-performance interface 1239. In one embodiment, the coprocessor 1238 is a special-purpose processor, such as, for example, a high-throughput MIC processor, a network or communication processor, compression engine, graphics processor, GPGPU, embedded processor, or the like.

A shared cache (not shown) may be included in either processor or outside of both processors, yet connected with the processors via P-P interconnect, such that either or both processors' local cache information may be stored in the shared cache if a processor is placed into a low power mode.

Chipset 1290 may be coupled to a first bus 1216 via an interface 1296. In one embodiment, first bus 1216 may be a Peripheral Component Interconnect (PCI) bus, or a bus such as a PCI Express bus or another third generation I/O interconnect bus, although the scope of the present invention is not so limited.

As shown in FIG. 12, various I/O devices 1214 may be coupled to first bus 1216, along with a bus bridge 1218 which couples first bus 1216 to a second bus 1220. In one embodiment, one or more additional processor(s) 1215, such as coprocessors, high-throughput MIC processors, GPGPU's, accelerators (such as, e.g., graphics accelerators or digital signal processing (DSP) units), field programmable gate arrays, or any other processor, are coupled to first bus 1216. In one embodiment, second bus 1220 may be a low pin count (LPC) bus. Various devices may be coupled to a second bus 1220 including, for example, a keyboard and/or mouse 1222, communication devices 1227 and a storage unit 1228 such as a disk drive or other mass storage device which may include instructions/code and data 1230, in one embodiment. Further, an audio I/O 1224 may be coupled to the second bus 1220. Note that other architectures are possible. For example, instead of the point-to-point architecture of FIG. 12, a system may implement a multi-drop bus or other such architecture.

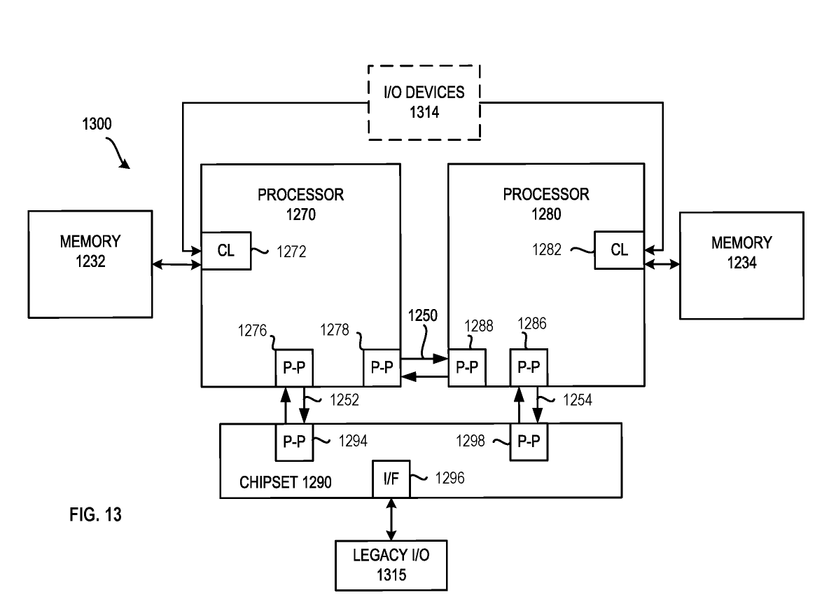

Referring now to FIG. 13, shown is a block diagram of a second more specific exemplary system 1300 in accordance with an embodiment of the present invention. Like elements in FIGS. 12 and 13 bear like reference numerals, and certain aspects of FIG. 12 have been omitted from FIG. 13 in order to avoid obscuring other aspects of FIG. 13.

FIG. 13 illustrates that the processors 1270, 1280 may include integrated memory and I/O control logic (“CL”) 1272 and 1282, respectively. Thus, the CL 1272, 1282 include integrated memory controller units and include I/O control logic. FIG. 13 illustrates that not only are the memories 1232, 1234 coupled to the CL 1272, 1282, but also that I/O devices 1314 are also coupled to the control logic 1272, 1282. Legacy I/O devices 1315 are coupled to the chipset 1290.

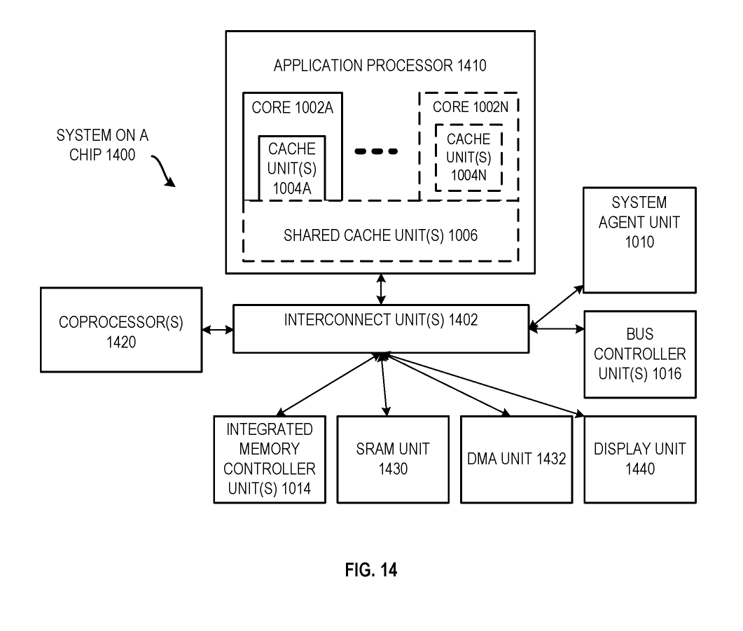

Referring now to FIG. 14, shown is a block diagram of a SoC 1400 in accordance with an embodiment of the present invention. Similar elements in FIG. 10 bear like reference numerals. Also, dashed lined boxes are optional features on more advanced SoCs. In FIG. 14, an interconnect unit(s) 1402 is coupled to: an application processor 1410 which includes a set of one or more cores 132A-N and shared cache unit(s) 1006; a system agent unit 1010; a bus controller unit(s) 1016; an integrated memory controller unit(s) 1014; a set or one or more coprocessors 1420 which may include integrated graphics logic, an image processor, an audio processor, and a video processor; an static random access memory (SRAM) unit 1430; a direct memory access (DMA) unit 1432; and a display unit 1440 for coupling to one or more external displays. In one embodiment, the coprocessor(s) 1420 include a special-purpose processor, such as, for example, a network or communication processor, compression engine, GPGPU, a high-throughput MIC processor, embedded processor, or the like.

Embodiments of the mechanisms disclosed herein may be implemented in hardware, software, firmware, or a combination of such implementation approaches. Embodiments of the invention may be implemented as computer programs or program code executing on programmable systems comprising at least one processor, a storage system (including volatile and non-volatile memory and/or storage elements), at least one input device, and at least one output device.

Program code, such as code 1230 illustrated in FIG. 12, may be applied to input instructions to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritable's (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments of the invention also include non-transitory, tangible machine-readable media containing instructions or containing design data, such as Hardware Description Language (HDL), which defines structures, circuits, apparatuses, processors and/or system features described herein. Such embodiments may also be referred to as program products.

Emulation (Including Binary Translation, Code Morphing, Etc.)

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

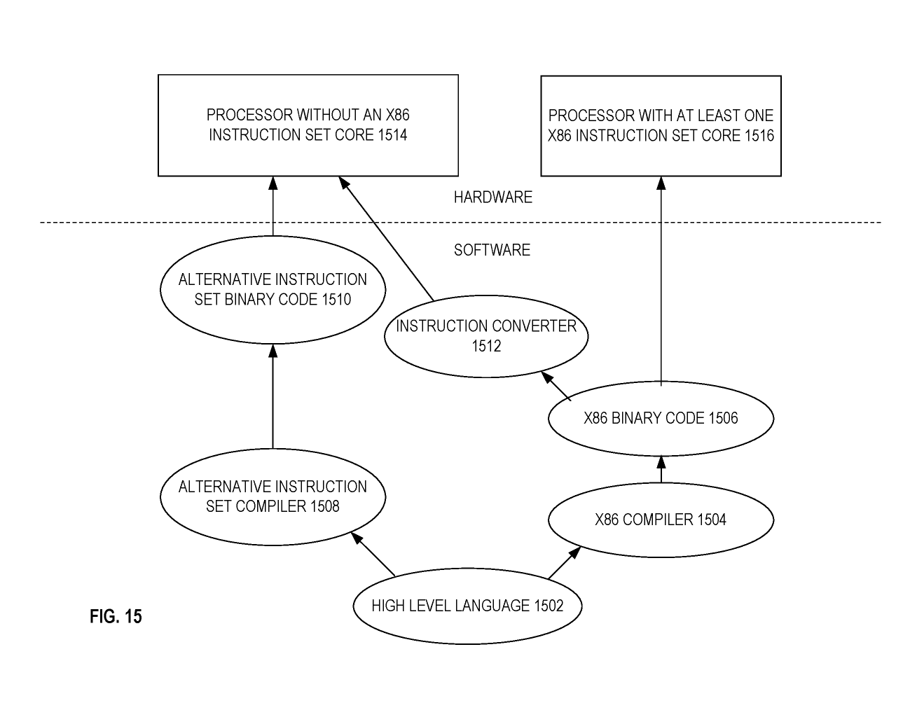

FIG. 15 is a block diagram contrasting the use of a software instruction converter to convert binary instructions in a source instruction set to binary instructions in a target instruction set according to embodiments of the invention. In the illustrated embodiment, the instruction converter is a software instruction converter, although alternatively the instruction converter may be implemented in software, firmware, hardware, or various combinations thereof. FIG. 15 shows a program in a high level language 1502 may be compiled using an x86 compiler 1504 to generate x86 binary code 1506 that may be natively executed by a processor with at least one x86 instruction set core 1516. The processor with at least one x86 instruction set core 1516 represents any processor that can perform substantially the same functions as an Intel processor with at least one x86 instruction set core by compatibly executing or otherwise processing (1) a substantial portion of the instruction set of the Intel x86 instruction set core or (2) object code versions of applications or other software targeted to run on an Intel processor with at least one x86 instruction set core, in order to achieve substantially the same result as an Intel processor with at least one x86 instruction set core. The x86 compiler 1504 represents a compiler that is operable to generate x86 binary code 1506 (e.g., object code) that can, with or without additional linkage processing, be executed on the processor with at least one x86 instruction set core 1516. Similarly, FIG. 15 shows the program in the high level language 1502 may be compiled using an alternative instruction set compiler 1508 to generate alternative instruction set binary code 1510 that may be natively executed by a processor without at least one x86 instruction set core 1514 (e.g., a processor with cores that execute the MIPS instruction set of MIPS Technologies of Sunnyvale, Calif. and/or that execute the ARM instruction set of ARM Holdings of Sunnyvale, Calif.). The instruction converter 1512 is used to convert the x86 binary code 1506 into code that may be natively executed by the processor without an x86 instruction set core 1514. This converted code is not likely to be the same as the alternative instruction set binary code 1510 because an instruction converter capable of this is difficult to make; however, the converted code will accomplish the general operation and be made up of instructions from the alternative instruction set. Thus, the instruction converter 1512 represents software, firmware, hardware, or a combination thereof that, through emulation, simulation or any other process, allows a processor or other electronic device that does not have an x86 instruction set processor or core to execute the x86 binary code 1506.

Components, features, and details described for any of FIGS. 1 and 4-7 may also optionally apply to any of FIGS. 2-3. Components, features, and details described for any of the processors disclosed herein may optionally apply to any of the methods disclosed herein, which in embodiments may optionally be performed by and/or with such processors. Any of the processors described herein (e.g., processor 201, processor 701) in embodiments may optionally be included in any of the systems disclosed herein (e.g., any of the systems of Figures xx-xx).

In the description and claims, the terms “coupled” and/or “connected,” along with their derivatives, may have be used. These terms are not intended as synonyms for each other. Rather, in embodiments, “connected” may be used to indicate that two or more elements are in direct physical and/or electrical contact with each other. “Coupled” may mean that two or more elements are in direct physical and/or electrical contact with each other. However, “coupled” may also mean that two or more elements are not in direct contact with each other, but yet still co-operate or interact with each other. For example, cache controller may be coupled with a decode unit through one or more intervening components. In the figures, arrows are used to show connections and couplings.

The components disclosed herein and the methods depicted in the preceding figures may be implemented with logic, modules, or units that includes hardware (e.g., transistors, gates, circuitry, etc.), firmware (e.g., a non-volatile memory storing microcode or control signals), software (e.g., stored on a non-transitory computer readable storage medium), or a combination thereof. In some embodiments, the logic, modules, or units may include at least some or predominantly a mixture of hardware and/or firmware potentially combined with some optional software.

The term “and/or” may have been used. As used herein, the term “and/or” means one or the other or both (e.g., A and/or B means A or B or both A and B).

In the description above, specific details have been set forth in order to provide a thorough understanding of the embodiments. However, other embodiments may be practiced without some of these specific details. The scope of the invention is not to be determined by the specific examples provided above, but only by the claims below. In other instances, well-known circuits, structures, devices, and operations have been shown in block diagram form and/or without detail in order to avoid obscuring the understanding of the description. Where considered appropriate, reference numerals, or terminal portions of reference numerals, have been repeated among the figures to indicate corresponding or analogous elements, which may optionally have similar or the same characteristics, unless specified or clearly apparent otherwise.

Certain operations may be performed by hardware components, or may be embodied in machine-executable or circuit-executable instructions, that may be used to cause and/or result in a machine, circuit, or hardware component (e.g., a processor, potion of a processor, circuit, etc.) programmed with the instructions performing the operations. The operations may also optionally be performed by a combination of hardware and software. A processor, machine, circuit, or hardware may include specific or particular circuitry or other logic (e.g., hardware potentially combined with firmware and/or software) is operative to execute and/or process the instruction and store a result in response to the instruction.

Some embodiments include an article of manufacture (e.g., a computer program product) that includes a machine-readable medium. The medium may include a mechanism that provides, for example stores, information in a form that is readable by the machine. The machine-readable medium may provide, or have stored thereon, an instruction or sequence of instructions, that if and/or when executed by a machine are operative to cause the machine to perform and/or result in the machine performing one or operations, methods, or techniques disclosed herein.

In some embodiments, the machine-readable medium may include a tangible and/or non-transitory machine-readable storage medium. For example, the non-transitory machine-readable storage medium may include a floppy diskette, an optical storage medium, an optical disk, an optical data storage device, a CD-ROM, a magnetic disk, a magneto-optical disk, a read only memory (ROM), a programmable ROM (PROM), an erasable-and-programmable ROM (EPROM), an electrically-erasable-and-programmable ROM (EEPROM), a random access memory (RAM), a static-RAM (SRAM), a dynamic-RAM (DRAM), a Flash memory, a phase-change memory, a phase-change data storage material, a non-volatile memory, a non-volatile data storage device, a non-transitory memory, a non-transitory data storage device, or the like. The non-transitory machine-readable storage medium does not consist of a transitory propagated signal. In some embodiments, the storage medium may include a tangible medium that includes solid-state matter or material, such as, for example, a semiconductor material, a phase change material, a magnetic solid material, a solid data storage material, etc. Alternatively, a non-tangible transitory computer-readable transmission media, such as, for example, an electrical, optical, acoustical or other form of propagated signals—such as carrier waves, infrared signals, and digital signals, may optionally be used.

Examples of suitable machines include, but are not limited to, a general-purpose processor, a special-purpose processor, a digital logic circuit, an integrated circuit, or the like. Still other examples of suitable machines include a computer system or other electronic device that includes a processor, a digital logic circuit, or an integrated circuit. Examples of such computer systems or electronic devices include, but are not limited to, desktop computers, laptop computers, notebook computers, tablet computers, netbooks, smartphones, cellular phones, servers, network devices (e.g., routers and switches.), Mobile Internet devices (MIDs), media players, smart televisions, nettops, set-top boxes, and video game controllers.

Reference throughout this specification to “one embodiment,” “an embodiment,” “one or more embodiments,” “some embodiments,” for example, indicates that a particular feature may be included in the practice of the invention but is not necessarily required to be. Similarly, in the description various features are sometimes grouped together in a single embodiment, Figure, or description thereof for the purpose of streamlining the disclosure and aiding in the understanding of various inventive aspects. This method of disclosure, however, is not to be interpreted as reflecting an intention that the invention requires more features than are expressly recited in each claim. Rather, as the following claims reflect, inventive aspects lie in less than all features of a single disclosed embodiment. Thus, the claims following the Detailed Description are hereby expressly incorporated into this Detailed Description, with each claim standing on its own as a separate embodiment of the invention.

### Example Embodiments

The following examples pertain to further embodiments. Specifics in the examples may be used anywhere in one or more embodiments.

Example 1 is a processor including a plurality of caches at a plurality of different cache levels, and a decode unit to decode a fetch instruction. The fetch instruction to indicate address information for a memory location, and the fetch instruction to indicate a cache level of the plurality of different cache levels. The processor also includes a cache controller coupled with the decode unit, and coupled with a cache at the indicated cache level. The cache controller, in response to the fetch instruction, to store data associated with the memory location in the cache. The fetch instruction is architecturally guaranteed to be completed.

Example 2 includes the processor of Example 1, in which the fetch instruction is to be performed by the processor as a demand load.

Example 3 includes the processor of Example 1, in which the fetch instruction is to be performed by the processor with a same priority as a load instruction that is to be used to load data from a memory location to an architectural register of the processor.

Example 4 includes the processor of Example 1, in which the decode unit is also to decode a prefetch instruction that is to indicate address information for a memory location, and in which the prefetch instruction is not architecturally guaranteed to be completed.

Example 5 includes the processor of Example 1, in which the processor is to complete performance of the fetch instruction without storing the data associated with the memory location in any architectural registers of the processor.

Example 6 includes the processor of any one of Examples 1 to 5, in which the decode unit is to decode the fetch instruction that is to have a cache level indication field to have a value to indicate the cache level.

Example 7 includes the processor of any one of Examples 1 to 5, in which the decode unit is to decode the fetch instruction that is to indicate the cache level as being any one of at least a level one (L1) data cache and a L1 instruction cache.

Example 8 includes the processor of Example 7, optionally in which the decode unit is to decode the fetch instruction that is to indicate the cache level as being any one of at least the L1 data cache, the L1 instruction cache, a level two (L2) cache, and a level three (L3) cache.

Example 9 includes the processor of any one of Examples 1 to 5, in which the decode unit is to decode the fetch instruction that is to indicate an amount of the data that is to be stored in the cache.

Example 10 includes the processor of Example 9, in which the fetch instruction is to indicate the amount of the data that is to be stored in the cache as any one of at least four different amounts of data. Also, optionally in which the at least four different amounts of data range from a single cache line to a maximum number of cache lines that fit within a page.

Example 11 includes the processor of Example 9, in which the decode unit is to decode the fetch instruction that is to have a data amount field to have a value to indicate the amount of the data.

Example 12 includes the processor of any one of Examples 1 to 5, further including a commit unit. Also, optionally in which the commit unit is to commit the fetch instruction before the data associated with the memory location is to have been stored in the cache.

Example 13 is a method performed by a processor including receiving, at the processor, a fetch instruction. The fetch instruction indicating address information for a memory location, and the fetch instruction indicating a cache level as being any one of a plurality of different cache levels. The method also includes storing, in response to the fetch instruction, data associated with the memory location in a cache of the processor which is at the indicated cache level. The fetch instruction is architecturally guaranteed to be completed by the processor.

Example 14 includes the method of Example 13, further including completing performance of the fetch instruction without storing the data associated with the memory location in any architectural registers of the processor.

Example 15 includes the method of Example 13, further including performing the fetch instruction with a same priority as a load instruction used to load data from a memory location to an architectural register of the processor.

Example 16 includes the method of Example 13, further including performing the fetch instruction as a demand load.

Example 17 includes the method of any one of Examples 13 to 16, in which receiving includes receiving the fetch instruction that indicates an amount of the data.

Example 18 includes the method of Example 17, in which receiving includes receiving the fetch instruction that is able to indicate the amount of the data as any one of at least four different amounts of data that range from a single cache line to a maximum number of cache lines that fit within a page.

Example 19 includes the method of any one of Examples 13 to 16, in which receiving includes receiving the fetch instruction that is able to indicate the cache level as being any one of at least a level one (L1) data cache, an L1 instruction cache, and a level two (L2) cache.

Example 20 includes the method of any one of Examples 13 to 16, further including committing the fetch instruction before the data associated with the memory location is stored in the cache.

Example 21 includes the method of any one of Examples 13 to 16, performed while performing a real time application on the processor which is a general-purpose central processing unit (CPU).

Example 22 is a system to process instructions including an interconnect, and a processor coupled with the interconnect. The processor including a plurality of caches at a plurality of different cache levels. The processor to receive a fetch instruction. The fetch instruction to indicate address information for a memory location, and to indicate a cache level of a plurality of different cache levels. The processor, in response to the fetch instruction, to store data associated with the memory location in a cache at the indicated cache level. The fetch instruction is architecturally guaranteed to be completed. The system also includes a dynamic random access memory (DRAM) coupled with the interconnect. The DRAM storing instructions of a real time application. The instructions of the real time application including the fetch instruction. The instructions of the real time application to use the fetch instruction to deterministically store the data to the cache at the indicated cache level.

Example 23 includes the system of Example 23, in which the fetch instruction is to indicate an amount of the data.

Example 24 is an article of manufacture including a non-transitory machine-readable storage medium. The non-transitory machine-readable storage medium storing a fetch instruction. The fetch instruction to indicate address information for a memory location, and the fetch instruction to indicate a cache level as being any one of a plurality of different cache levels. The fetch instruction if executed by a machine is to cause the machine to perform operations including storing data associated with the memory location in a cache of the processor which is at the indicated cache level. The fetch instruction is architecturally guaranteed to be completed by the machine.

Example 25 includes the article of manufacture of Example 24, in which the non-transitory machine-readable storage medium further stores a set of instructions that if executed by the machine cause the machine to implement a real time algorithm. Also, optionally in which the set of instructions include and use the fetch instruction to deterministically store the data to the indicated cache level, in which the fetch instruction is to indicate an amount of the data.

Example 26 includes the processor of any one of Examples 1 to 12, further including an optional branch prediction unit to predict branches, and an optional instruction prefetch unit, coupled with the branch prediction unit, the instruction prefetch unit to prefetch instructions including the fetch instruction. The processor may also optionally include an optional level 1 (L1) instruction cache coupled with the instruction prefetch unit, the L1 instruction cache to store instructions, an optional L1 data cache to store data, and an optional level 2 (L2) cache to store data and instructions. The processor may also optionally include an instruction fetch unit coupled with the decode unit, the L1 instruction cache, and the L2 cache, to fetch the fetch instruction, in some cases from one of the L1 instruction cache and the L2 cache, and to provide the fetch instruction to the decode unit. The processor may also optionally include a register rename unit to rename registers, an optional scheduler to schedule one or more operations that have been decoded from the fetch instruction for execution, and an optional commit unit to commit execution results of the fetch instruction.

Example 27 includes a system-on-chip that includes at least one interconnect, the processor of any one of Examples 1 to 12 coupled with the at least one interconnect, an optional graphics processing unit (GPU) coupled with the at least one interconnect, an optional digital signal processor (DSP) coupled with the at least one interconnect, an optional display controller coupled with the at least one interconnect, an optional memory controller coupled with the at least one interconnect, an optional wireless modem coupled with the at least one interconnect, an optional image signal processor coupled with the at least one interconnect, an optional Universal Serial Bus (USB) 3.0 compatible controller coupled with the at least one interconnect, an optional Bluetooth 4.1 compatible controller coupled with the at least one interconnect, and an optional wireless transceiver controller coupled with the at least one interconnect.

Example 28 is a processor or other apparatus operative to perform the method of any one of Examples 13 to 21.

Example 29 is a processor or other apparatus that includes means for performing the method of any one of Examples 13 to 21.

Example 30 is a processor or other apparatus that includes any combination of modules and/or units and/or logic and/or circuitry and/or means operative to perform the method of any one of Examples 13 to 21.

Example 31 is an optionally non-transitory and/or tangible machine-readable medium, which optionally stores or otherwise provides instructions including a first instruction, the first instruction if and/or when executed by a processor, computer system, electronic device, or other machine, is operative to cause the machine to perform the method of any one of Examples 13 to 21.

Example 32 is a processor or other apparatus substantially as described herein.

Example 33 is a processor or other apparatus that is operative to perform any method substantially as described herein.

Example 34 is a processor or other apparatus that is operative to perform any fetch instruction substantially as described herein.

Example 35 is a computer system or other electronic device that includes a processor having a decode unit operative to decode instructions of a first instruction set. The processor also has one or more execution units. The electronic device also includes a storage device coupled with the processor. The storage device is operative to store a first instruction, which may be any of the instructions substantially as disclosed herein, and which is to be of a second different instruction set. The storage device is also operative to store instructions to convert the first instruction into one or more instructions of the first instruction set. The one or more instructions of the first instruction set, when performed by the processor, are operative to cause the processor to load data and store the loaded data as would be done by the first instruction.

What is claimed is:

1. A processor comprising:
a plurality of caches at a plurality of different cache levels;
a decode unit to decode a fetch instruction, the fetch instruction to indicate address information for a memory location, and the fetch instruction to indicate a cache level of the plurality of different cache levels; and
a cache controller coupled with the decode unit, and coupled with a cache at the indicated cache level, the cache controller, in response to the fetch instruction, to store data associated with the memory location in the cache, wherein the fetch instruction is architecturally guaranteed to be completed.

2. The processor of claim 1, wherein the fetch instruction is to be performed by the processor as a demand load.

3. The processor of claim 1, wherein the fetch instruction is to be performed by the processor with a same priority as a load instruction that is to be used to load data from a memory location to an architectural register of the processor.

4. The processor of claim 1, wherein the decode unit is also to decode a prefetch instruction that is to indicate address information for a memory location, and wherein the prefetch instruction is not architecturally guaranteed to be completed.

5. The processor of claim 1, wherein the processor is to complete performance of the fetch instruction without storing the data associated with the memory location in any architectural registers of the processor.

6. The processor of claim 1, wherein the decode unit is to decode the fetch instruction that is to have a cache level indication field to have a value to indicate the cache level.

7. The processor of claim 1, wherein the decode unit is to decode the fetch instruction that is to indicate the cache level as being any one of at least a level one (L1) data cache and a L1 instruction cache.

8. The processor of claim 7, wherein the decode unit is to decode the fetch instruction that is to indicate the cache level as being any one of at least the L1 data cache, the L1 instruction cache, a level two (L2) cache, and a level three (L3) cache.

9. The processor of claim 1, wherein the decode unit is to decode the fetch instruction that is to indicate an amount of the data that is to be stored in the cache.

10. The processor of claim 9, wherein the fetch instruction is to indicate the amount of the data that is to be stored in the cache as any one of at least four different amounts of data that range from a single cache line to a maximum number of cache lines that fit within a page.

11. The processor of claim 9, wherein the decode unit is to decode the fetch instruction that is to have a data amount field to have a value to indicate the amount of the data.

12. The processor of claim 1, further comprising a commit unit, and wherein the commit unit is to commit the fetch instruction before the data associated with the memory location is to have been stored in the cache.

13. A method performed by a processor comprising:
receiving, at the processor, a fetch instruction, the fetch instruction indicating address information for a memory location, and the fetch instruction indicating a cache level as being any one of a plurality of different cache levels; and
storing, in response to the fetch instruction, data associated with the memory location in a cache of the processor which is at the indicated cache level, wherein the fetch instruction is architecturally guaranteed to be completed by the processor.

14. The method of claim 13, further comprising completing performance of the fetch instruction without storing the data associated with the memory location in any architectural registers of the processor.

15. The method of claim 13, further comprising performing the fetch instruction with a same priority as a load instruction used to load data from a memory location to an architectural register of the processor.

16. The method of claim 13, further comprising performing the fetch instruction as a demand load.

17. The method of claim 13, wherein receiving comprises receiving the fetch instruction that indicates an amount of the data.

18. The method of claim 17, wherein receiving comprises receiving the fetch instruction that is able to indicate the amount of the data as any one of at least four different amounts of data that range from a single cache line to a maximum number of cache lines that fit within a page.

19. The method of claim 13, wherein receiving comprises receiving the fetch instruction that is able to indicate the cache level as being any one of at least a level one (L1) data cache, an L1 instruction cache, and a level two (L2) cache.

20. The method of claim 13, further comprising committing the fetch instruction before the data associated with the memory location is stored in the cache.

21. The method of claim 13, performed while performing a real time application on the processor which is a general-purpose central processing unit (CPU).

22. A system to process instructions comprising:
an interconnect;
a processor coupled with the interconnect, the processor including a plurality of caches at a plurality of different cache levels, the processor to receive a fetch instruction, the fetch instruction to indicate address information for a memory location, and to indicate a cache level of a plurality of different cache levels, the processor, in response to the fetch instruction, to store data associated with the memory location in a cache at the indicated cache level, wherein the fetch instruction is architecturally guaranteed to be completed; and
a dynamic random access memory (DRAM) coupled with the interconnect, the DRAM storing instructions of a real time application, the instructions of the real time application including the fetch instruction, the instructions of the real time application to use the fetch instruction to deterministically store the data to the cache at the indicated cache level.

23. The system of claim 23, wherein the fetch instruction is to indicate an amount of the data.

24. An article of manufacture comprising a non-transitory machine-readable storage medium, the non-transitory machine-readable storage medium storing a fetch instruction, the fetch instruction to indicate address information for a memory location, and the fetch instruction to indicate a cache level as being any one of a plurality of different cache levels, the fetch instruction if executed by a machine is to cause the machine to perform operations comprising:
storing data associated with the memory location in a cache of the processor which is at the indicated cache level, wherein the fetch instruction is architecturally guaranteed to be completed by the machine.

25. The article of manufacture of claim 24, wherein the non-transitory machine-readable storage medium further stores a set of instructions that if executed by the machine cause the machine to implement a real time algorithm, wherein the set of instructions include and use the fetch instruction to deterministically store the data to the indicated cache level, wherein the fetch instruction is to indicate an amount of the data.
